(19) United States
(12) Patent Application Publication
(10) Pub. No.: US 2010/0040854 A1
(43) Pub. Date: Feb. 18, 2010

(54) CELLULOSE ACYLATE FILM AND POLARIZER

(75) Inventors: Ryousuke Takada, Minami-ashigara-shi (JP); Jun Takeda, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/540,427

(22) Filed: Aug. 13, 2009

(30) Foreign Application Priority Data
Aug. 13, 2008 (JP) 2008-208742
Jul. 15, 2009 (JP) 2009-166674

(51) Int. Cl. B32B 23/20; C09D 101/08; C09D 101/12

(52) U.S. Cl. 428/220; 106/163.01; 106/171.1

(57) ABSTRACT

A cellulose acylate film comprising at least one compound having a negative birefringence and satisfying 30 nm<Re<100 nm and 80 nm<Rth<300 nm is excellent in the wet heat durability of Re and Rth.

### BACKGROUND OF THE INVENTION

1. Field of the Invention

The present invention relates to a cellulose acylate film, of which the retardation each in the in-plane direction and in the thickness direction is within a specific range, which is excellent in the wet heat durability of the retardation in the in-plane direction and in the thickness direction thereof and of which the haze level is sufficiently low. Precisely, the invention relates to a cellulose acylate film which has been improved in point of the wet heat durability of the optical properties thereof by adding an additive having a specific structure thereto, and which is useful in liquid-crystal display devices and which hardly whitens, and to a polarizer produced by the use of the cellulose acylate film.

2. Description of the Related Art

In general, a liquid crystal display device comprises a liquid crystal cell, an optically-compensatory film, and a polarizing element. The optically-compensatory film serves to cancel image coloration and to enlarge a viewing angle, including a stretched birefringent film and a film produced by coating a transparent film with a liquid crystal. For example, Japanese Patent No. 2587398 discloses a technique of applying an optically-compensatory film prepared by applying a discotic liquid crystal to a triacetyl cellulose film and aligning and fixing it thereon, to a TN-mode liquid crystal cell to thereby enlarge a viewing angle.

However, for a liquid crystal display device for TVs that are expected to be watched at various angles on a large-size panel, the requirement in point of the viewing angle dependence thereof is severe, and still could not be on a satisfactory level even though the above-mentioned technique is applied thereto. Accordingly, others than TN-mode liquid crystal display devices, such as IPS (in-plane switching) mode, OCB (optically compensatory bend) mode and VA (vertically aligned) mode devices are now under investigations. In particular, VA-mode devices have a high contrast and the production yield thereof is relatively high, and therefore they are now being in the mainstream of liquid crystal display devices for TV.

As the material of the polarizing element that is indispensable in a liquid crystal display device, in general, polyvinylalcohol (hereinafter this may be referred to as “PVA”) is mainly used. A PVA film is monoaxially stretched and then colored with iodine or a dichroic dye, or after colored, it is stretched, and thereafter the resulting film is crosslinked with a boron compound to have a polarizing ability, and is used as a polarizing element.

For use that requires optical isotropy as in protective films for polarizers, cellulose acylate films are generally used. This is based on the characteristics thereof in that cellulose acylate films have a higher optical isotropy (having a lower retardation) as compared with other polymer films.

On the other hand, an optically-compensatory film (retardation film) in liquid crystal display devices is required to have an optical anisotropy (a high retardation) contrary to the above. Especially an optically-compensatory film for use in VA mode devices is required to have an Re (Re indicates the in-plane retardation of the film.) from 30 to 100 nm and an Rth (Rth indicates retardation in the thickness direction of the film.) from 80 to 300 nm. Accordingly, as the optically-compensatory film, heretofore generally used are synthetic polymer films having a high retardation, such as polycarbonate films and polysulfone films.

Specifically, the general principle of optical members for use in liquid crystal display devices is that synthetic polymer films are used in case where the polymer films are required to have an optical anisotropy (a high retardation), but cellulose acylate films are used in case where the films are required to have an optical isotropy (a low retardation).

In EP-A 911656, proposed is a cellulose acetate film having a high retardation which is applicable also to use that requires an optical anisotropy, contrary to the conventional general principle. In this proposal, an aromatic compound having at least two aromatic rings, especially a compound having 1,3,5-triazine rings is added to a cellulose triacetate film and the film is stretched to thereby realize a high retardation of the film. In general, cellulose triacetate is a hardly-stretchable polymer material, and it is known that the birefringence of the film is difficult to increase; however, the additive in the film is also oriented therein through the stretching treatment of the film, whereby the birefringence of the stretched film can be increased and a high retardation of the resulting film is thereby realized. The film can serve also as a protective film of a polarizer, and therefore has an advantage in that the necessary member films constituting a liquid crystal display device can be reduced, and inexpensive and thin-body liquid crystal display devices can be provided.

The methods disclosed in EP-A 911656 and JP 2587398 is useful in that thin liquid crystal display devices are manufactured economically.

Recently, use of liquid crystal display devices is increasing more and more, and the devices for outdoor use and those for in-car use are much increasing. Accordingly, liquid crystal display devices favorable for use in wet heat environments are being required.

For example, as a method for improving the moisture permeability of a cellulose acylate film in use in wet heat environments, a method of increasing the amount of the additive to the film is proposed (See JP-A 2002-22956 and JP-A 2001-354802)).

Further recently, it has become desired to improve the durability of the optical properties of the film in long-term use in wet heat environments, but conventional additives are ineffective for improving the film.

On the other hand, there is known a method of improving the properties of films by adding styrenic additives to various resins. For example, there is disclosed an example of trying relieving the humidity dependence of films by adding a styrene/maleic anhydride additive to a cellulose acylate resin and further adding an antioxidant thereto (JP-A 2007-304376); however, nothing is referred to therein relating to the optical properties of the films. Also disclosed is an example of trying improving the wavelength dispersion characteristics of retardation of films by adding a styrene/maleic anhydride additive to a norbornene resin (JP-A 2001-337222); however, nothing is referred to therein relating to the improvement in the retardation of the films and to the usefulness of the styrenic additive under high-temperature high-humidity conditions.

At present, as in the above, technical development is assiduously desired in the art for a transparent protective film and an optically-compensatory film for use for polarizers, which is excellent in the durability of the optical properties thereof that control display performance, for which the production process is not complicated, which does not whiten, and for which the materials are not expensive, for a polarizer comprising the film, and for a liquid-crystal display device comprising it.

### SUMMARY OF THE INVENTION

However, the present inventors' investigations have revealed that a cellulose acylate film containing an increased amount of an ordinary additive added thereto could not satisfy the wet heat durability of the optical properties of the film but on the contrary, the increase in the amount of the additive to be added to the film rather lowers the wet heat durability of the optical properties of the film. In addition, the investigations have further revealed that the mere addition of a known styrenic additive to a cellulose acylate film could not readily improve the wet heat durability of the optical properties of the film while keeping high retardation in the in-plane direction and in the thickness direction of the film.

Further, addition of too much additive has caused a problem in that the additive may precipitate on the surface of the film being formed or may form particles during saponification treatment or may form crystals. In other words, the method is ineffective for improving the wet heat durability of the optical properties of the film and additionally causes some problems in that the additive precipitates out in the web during formation of the cellulose acylate film in solution casting film formation and fouls the apparatus and the film itself, therefore degrading the quality and the producibility of the film.

The present inventors have developed a cellulose acylate film which has overcome the above-mentioned problems and is excellent in the wet heat durability of the retardation in the in-plane direction and the thickness-direction of the film, of which the haze is sufficiently low and which is useful for liquid-crystal display devices. As a result, the inventors have clarified that, when an additive having a specific structure and having a negative birefringence is added to the film so as to increase the retardation of the film, then the wet heat durability of the retardation in the in-plane direction and the thickness-direction of the film is enhanced and the haze of the film is reduced. The effect brought about by the constitution is a surprising one that could not be anticipated from the related prior art.

A first object of the invention is to provide a cellulose acylate film of which the retardation in the in-plane direction and the thickness direction falls within a specific range, which is excellent in the wet heat durability of the retardation in the in-plane direction and the thickness direction thereof, and of which the haze is sufficiently low. A second object of the invention is to provide a polarizer produced by the use of the film.

The inventors have assiduously studied and, as a result, have provided the invention described below.

[1] A cellulose acylate film comprising a cellulose acylate resin and at least one compound having a negative birefringence and satisfying the following inequalities (a) and (b):

30 nm<Re<100 nm (a)

80 nm<Rth<300 nm (b)

wherein Re indicates retardation in the plane of the cellulose acylate film and Rth indicates retardation in the thickness direction of the cellulose acylate film.
[2] The cellulose acylate film of [1], wherein the retardation in the plane of the cellulose acylate film changes by from −10% to 10% and the retardation in the thickness direction of the cellulose acylate film changes by from −10% to 10% after the cellulose acylate film is kept at 60° C. and relative humidity 90% for 150 hours.
[3] The cellulose acylate film of [1] or [2], wherein the cellulose acylate film is a stretched film.
[4] The cellulose acylate film of any one of [1] to [3], comprising at least one retardation enhancer.
[5] The cellulose acylate film of any one of [1] to [4], wherein the compound having a negative birefringence has a weight-average molecular weight of from 1000 to 100000.
[6] The cellulose acylate film of any one of [1] to [5], wherein the cellulose acylate resin has a degree of acyl substitution of from 2.0 to 2.95.
[7] The cellulose acylate film of any one of [1] to [6], wherein the cellulose acylate resin is a cellulose acetate resin.
[8] The cellulose acylate film of any one of [1] to [7], having a thickness of from 30 to 100 μm.
[9] A polarizer comprising the cellulose acylate film of any one of [1] to [8].

Containing a compound having a negative intrinsic birefringence, the cellulose acylate film of the invention is protected from the change in the retardation in the in-plane direction and the thickness direction thereof in long-term and high-temperature high-humidity conditions. In addition, the retardation in the in-plane direction and the thickness direction of the film is within a specific range, and in particular, Rth of the film is high; and therefore, the film is favorably used in TN-mode and VA-mode liquid-crystal display devices. Further, the haze of the film is low, and the film is not whitened. Accordingly, the invention is favorable for a transparent protective film and an optically-compensatory film for polarizers, and for a polarizer and a liquid-crystal display device comprising the film.

### BEST MODE FOR CARRYING OUT THE INVENTION

Description will now be made in detail of the cellulose acylate film and polarizer according to the invention. Although the following description of its structural features may often be made on the basis of typical embodiments of the invention, it is to be understood that the invention is not limited to any such embodiment. It is also to be noted that every numerical range as herein expressed by employing the words “from” and “to”, or simply the word “to”, or the symbol “˜” is supposed to include the lower and upper limits thereof as defined by such words or symbol, unless otherwise noted. It is also to be noted that “a compound having a negative birefringence” is sometimes called as “a negative birefringence compound” or “a compound exhibiting a negative birefringence”. In the invention, “mass %” means equal to “weight %”, and “% by mass” means equal to “% by weight”.

### [Cellulose Acylate]

The cellulose acylate for use for the cellulose acylate film of the invention is obtained through substitution of the hydroxyl group of the glucose unit that constitutes the cellulose acylate, with an acyl group.

Cellulose used as a starting material in preparation for the cellulose acylate used in the invention includes cotton linter and wood pulp (broadleaf pulp, coniferous pulp), etc. Any cellulose acylate obtained from any of such a starting cellulose may be used. As the case may be, a mixture of different cellulose acylates may also be used herein. The details of the cellulose as a starting material are described, for example, in “Plastic Material Lecture (17), Cellulosic Resin” (written by Marusawa, Uda, published by Nikkan Kogyo Shinbun-sha, 1970); and Hatsumei Kyokai Disclosure Bulletin 2001-1745 (pp. 7-8). Cellulose used in the cellulose acylate film of the invention is not specifically limited.

(Cellulose Acylate)

Description will first be made in detail of the cellulose acylate preferably used for the invention. The glucose units having a β-1,4 bond and forming the cellulose have free hydroxyl groups in the 2-, 3- and 6-positions thereof. The cellulose acylate is a polymer obtained by esterifying a part or all of those hydroxyl groups with an acyl group. Its degree of acyl substitution means the total of the esterification degrees of cellulose in each 2-, 3- and 6-position (an esterification degree in each position of 100% meaning a substitution degree of 1).

(Degree of Substitution)

The total degree of acyl substitution (DS), which means the sum of the degree of substitution with each acyl group, is preferably 2.0≦DS≦2.95, more preferably 2.2≦DS≦2.85, even more preferably 2.4≦DS≦2.8. Having a total degree of acyl substitution that falls within the range, water vapor permeation resistance and retardation of the film can be greatly enhanced, and the display performance stability of liquid crystal display devices comprising the film can be enhanced further more. Preferably, DS6/(DS2+DS3+DS6) is at least 0.32, more preferably at least 0.322, even more preferably from 0.324 to 0.340. DS2 is a degree of substitution with an acyl group of the 2-positioned hydroxyl group of the glucose unit constituting the cellulose ester (hereinafter this may be referred to as “degree of 2-position acyl substitution”); DS3 is a degree of substitution with an acyl group of the 3-positioned hydroxyl group (hereinafter this may be referred to as “degree of 3-position acyl substitution”); DS6 is a degree of substitution with an acyl group of the 6-positioned hydroxyl group (hereinafter this may be referred to as “degree of 6-position acyl substitution”). DS6/(DS2+DS3+DS6) indicates the ratio of the degree of 6-position acyl substitution to the total degree of substitution (hereinafter this may be referred to as “ratio of 6-position acyl substitution”).

(Acyl Group)

One or more different types of acyl groups may be in the cellulose acylate in the invention. Preferably, the cellulose acylate film of the invention has a substituent of an acyl group having from 2 to 4 carbon atoms. In case where the cellulose acylate film has two or more different types of acyl groups, preferably, one of them is an acetyl group. As the other acyl group having from 2 to 4 carbon atoms than the acetyl group, preferred are a propionyl group and a butyryl group. The sum total of the degree of substitution with an acetyl group of the 2-positioned, 3-positioned and 6-positioned hydroxyl groups is referred to as DSA; and the sum total of the degree of substitution with a propionyl or butyryl group of the 2-positioned, 3-positioned and 6-positioned hydroxyl groups is referred to as DSB. Preferably, the value of DSA+DSB is 2.0≦DSA+DSB≦2.7, more preferably 2.3≦DSA+DSB≦2.65, even more preferably 2.4≦DSA+DSB≦2.6. When DSA and DSB are specifically defined to fall within the above range, it is favorable since films of which Re and Rth change little depending on the ambient humidity, can be obtained.

Preferably, at least 28% of DSB is a degree of substitution of the 6-positioned hydroxyl group; more preferably at least 30% thereof is a degree of substitution of the 6-positioned hydroxyl group; even more preferably at least 31% thereof is a degree of substitution of the 6-positioned hydroxyl group; still more preferably at least 32% thereof is a degree of substitution of the 6-positioned hydroxyl group;

The acyl group in the cellulose used in the invention may be an aliphatic group or an aryl group, and are not particularly limited. They may be an alkylcarbonyl ester of cellulose, an alkenylcarbonyl ester of cellulose, an aromatic carbonyl ester of cellulose or an aromatic alkylcarbonyl ester of cellulose. These esters may have a substituent. Preferable examples of the substituents include an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an isobutanoyl group, a tert-butanoyl group, a cyclohexanecarbonyl group, an oleoyl group, a benzoyl group, a naphthylcarbonyl group and a cinnamoyl group. An acetyl group, a propionyl group, a butanoyl group, a dodecanoyl group, an octadecanoyl group, a tert-butanoyl group, an oleoyl group, a benzoyl group, a naphthylcarbonyl group and a cinnamoyl group are more preferred, and an acetyl group, a propionyl group and a butanoyl group are particularly preferred, and the most preferred is an acetyl group.

In acylation of cellulose, when an acid anhydride or an acid chloride is used as the acylating agent, the organic solvent as the reaction solvent may be an organic acid, such as acetic acid, or methylene chloride or the like.

When the acylating agent is an acid anhydride, the catalyst is preferably a protic catalyst such as sulfuric acid; and when the acylating agent is an acid chloride (e.g., CH₃CH₂COCl), a basic compound may be used as the catalyst.

A most popular industrial production method for a mixed fatty acid ester of cellulose comprises acylating cellulose with a fatty acid corresponding to an acetyl group and other acyl groups (e.g., acetic acid, propionic acid, valeric acid, etc.), or with a mixed organic acid ingredient containing their acid anhydride.

The cellulose ester for use in the invention can be produced, for example, according to the method described in JP-A 10-45804.

[Compound Having a Negative Birefringence]

A compound having a negative birefringence used in this invention is described in more detail.

The compound having a negative birefringence means a material which, in a cellulose acylate film, shows a negative birefringence relative to a specific direction of the film. In this description, the negative birefringence means that the birefringence index of the film is negative. The matter as to whether a compound has a negative birefringence or not may be known by measuring the birefringence of a film containing the compound and the birefringence of a film not containing the compound and analyzing the difference between them.

Not specifically defined, any and every known compound having a negative birefringence can be used in the invention.

The compound having a negative birefringence includes a polymer having a negative birefringence, and needle-like particles having a negative birefringence (including needle-like particles of a polymer having a negative birefringence). The polymer having a negative birefringence and the needle-like particles having a negative birefringence usable in the invention are described below.

### <Polymer Having a Negative Birefringence>

The polymer having a negative birefringence is such that, when light has come in the layer of the polymer where the molecules are monoaxially aligned, the refractive index of the light in the alignment direction is smaller than the refractive index of the light in the direction perpendicular to the alignment direction.

The polymer having a negative birefringence includes polymers having a specific cyclic structure, styrenic polymers such as polystyrene, styrene/maleic anhydride copolymer (SMA resin), etc.; acrylic polymers such as polymethylmethacrylate, etc.; cellulose ester polymers (except those having a positive birefringence); polyester polymers (except those having a positive birefringence); furanose or pyranose structure-having polymers; acrylonitrile polymers; alkoxysilyl polymers; and their polynary (e.g., binary, ternary) copolymers, etc. One or more different types of these polymers may be used herein either singly or as combined. The copolymers may be either block copolymers or random copolymers.

Of those, especially preferred are polymers having a specific cyclic structure, styrenic polymers, acrylic polymers, alkoxysilyl polymers; and more preferred are polyvinylpyrrolidone, polystyrene, poly-α-methylstyrene, polyhydroxystyrene, polyacrylate, polyacrylic ester, styrene/maleic anhydride copolymer.

(Polymer Having Specific Cyclic Structure in the Side Branch)

As the polymer having a negative birefringence, also preferred are polymers having a cyclic structure in the side branch thereof, which are represented by the following formula (1) or (2):

The polymer having a negative birefringence may have only any one cyclic structure of formula (1) or (2), and may have any other side branch.

### <Cyclic Structure Represented by Formula (1)>

Hereinafter describes a cyclic structure represented by the following formula (1).

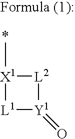

In formula (1), X¹ represents CR¹ or a nitrogen atom, and is preferably a nitrogen atom.

R¹ represents a hydrogen atom or a monovalent substituent. The monovalent substituent is not specifically defined. The monovalent substituent includes, for example, the substituents described just after the specific examples c1 to c15 of the linking group (c) in the section of explaining retardation enhancers given hereinunder.

Y¹ represents a carbon atom, a nitrogen atom or a sulfur atom, and is preferably a carbon atom or a sulfur atom, more preferably a carbon atom.

L¹ represents a single bond or an atomic linking group of which the linking chain consists of one atom. L¹ is preferably a single bond. Not specifically defined, the atomic linking group includes a divalent carbon atom-containing linking group, a divalent nitrogen atom-containing linking group, a sulfur atom, an oxygen atom, etc.

L² represents a linking group of which the linking chain consists of from 2 to 6 atoms. Preferably, in L², the linking chain consists of from 2 to 5 atoms, more preferably from 2 to 4 atoms. Not specifically defined, the linking group may be any divalent one, including, for example, a divalent carbon atom-containing linking group, a divalent nitrogen atom-containing linking group, etc. The linking group may further have a substituent. The substituent includes, for example, the substituents described just after the specific examples c1 to c15 of the linking group (c) in the section of explaining retardation enhancers given hereinunder.

L² is especially preferably a substituted or unsubstituted alkylene group having from 2 to 4 carbon atoms.

The cyclic structure represented by the formula (1) may form an aromatic ring, a hetero ring or an aromatic heterocyclic ring as a whole. The cyclic structure represented by the above formula (1) may have two or more cyclic structures or a condensed-ring, but a single cyclic structure or a monocyclic structure is preferable.

A preferred combination of X¹, Y¹, L¹ and L² is as follows: X¹ is a nitrogen atom, Y¹ is a carbon atom, L¹ is a single bond, and L² is a substituted or unsubstituted alkylene group having from 2 to 4 carbon atoms. More preferred are structures of the following formula (3) or (4).

(Cyclic Structure Represented by Formula (3) or (4))

### <Cyclic Structure Represented by Formula (3)>

First, hereinafter describes a cyclic structure represented by the following formula (3).

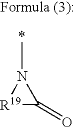

In formula (3), R¹⁹ represents a substituted or unsubstituted alkylene group having from 2 to 4 carbon atoms, and is more preferably a substituted or unsubstituted alkylene group having 3 carbon atoms.

The substituent includes, for example, the substituents described just after the specific examples c1 to c15 of the linking group (c) in the section of explaining retardation enhancers given hereinunder. The substituent may or may not have a structure of —C(═O)—, and when it has the structure of —C(═O)—, preferably, the structure is in a direction near to the direction parallel to —C(═O)— in the formula (3).

### <Cyclic Structure Represented by Formula (4)>

Next, hereinafter describes a cyclic structure represented by the following formula (4).

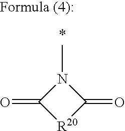

In formula (4), R²⁰ represents a substituted or unsubstituted alkylene group having from 1 to 3 carbon atoms. More preferably, R²⁰ is a substituted or unsubstituted alkylene group having 2 carbon atoms.

The substituent may be the same as that described for the formula (3). Its preferred range is also the same as in the formula (3).

The cyclic structure represented by the formula (1) is most preferably a pyrrolidone structure.

Specific examples of the cyclic structure represented by the formula (1), (3) or (4) are shown below. However the cyclic structure which can be used in the present invention is not limited to these specific examples below.

### Examples of the Cyclic Structure Represented by Formulae (1), (3) or (4):

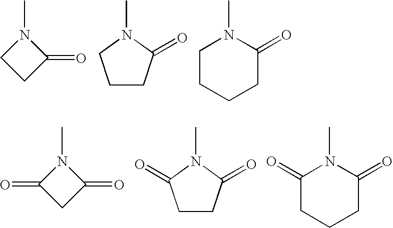

### <Cyclic Structure Represented by Formula (2)>

Hereinafter describes a cyclic structure represented by the following formula (2).

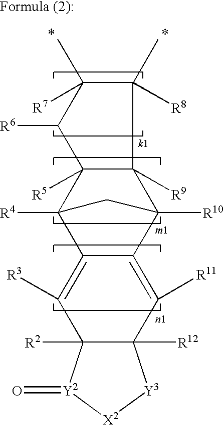

In formula (2), X² represents CR¹³R¹⁴, NR¹⁵, an oxygen atom or a sulfur atom. X² is preferably CR¹³R¹⁴ or NR¹⁵.

Y² represents a carbon atom, a nitrogen atom or a sulfur atom, and is preferably a carbon atom or a sulfur atom, more preferably a carbon atom.

Y³ represents CR¹⁶R¹⁷, NR¹⁸, an oxygen atom, a nitrogen atom, —C(═O)—, —N(═O)— or —S(═O)—, and is preferably —S(═O)— or —C(═O)—, more preferably —C(═O)—.

R² to R¹⁸ represent a hydrogen atom or a monovalent substituent, preferably a hydrogen atom, or a substituted or unsubstituted alkyl group having from 1 to 8 carbon atoms.

k1, m1 and n1 each independently represent an integer of from 0 to 2. k1 is preferably 0 or 1, more preferably 0. m1 is preferably 0 or 1. n1 is preferably 0 or 1. More preferably, the total of m1 and n1 is 0 or 1.

The structure in the parenthesis of k1, the structure in the parenthesis of m1 and the structure in the parenthesis of n1 may be in a random order.

The cyclic structure represented by the formula (2) may form an aromatic ring, a hetero ring or an aromatic heterocyclic ring. The cyclic structure represented by the formula (2) may have two or more cyclic structures or a condensed-ring, but a single cyclic structure or a monocyclic structure is preferable.

A preferred combination of X², Y², Y³, R² to R¹⁸, K1, m1 and n1 is as follows: X² is NR¹⁵, Y² is a carbon atom, Y³ is —C(═O)—, R² to R¹⁸ is a hydrogen atom, K1 is 0, m1 is 0 or 1 and n1 is 0 or 1. More preferred are structures represented by the following formula (5).

### <Cyclic Structure Represented by Formula (5)>

Hereinafter describes a cyclic structure represented by the following formula (5).

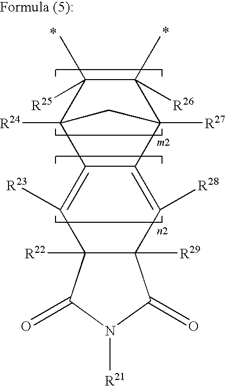

In formula (5), R²¹ represents a hydrogen atom, a group represented by the formula (5-1) shown below, a group represented by the formula (5-2) shown below, or a substituted or unsubstituted alkyl group having from 1 to 8 carbon atoms.

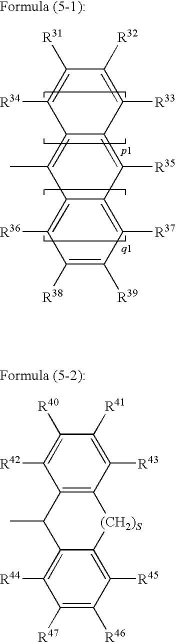

R³¹ to R⁴⁷ each independently represent an atom or a substituent selected from a hydrogen atom; a halogen atom; a substituted or unsubstituted hydrocarbon atom having from 1 to 30 carbon atoms and optionally having a linking group containing an oxygen atom, a sulfur atom or a silicon atom; and a polar group.

In formula (5-1), p1 and q1 each indicate 0 or a positive integer; and when p1=q1=0, R³² and R³⁵, or R³⁵ and R³⁹ may bond to each other to form a monocyclic or polycyclic group optionally having a hetero atom.

In formula (5-2), s indicates 0 or an integer of 1 or more.

R²² to R²⁹ represents a hydrogen atom, or a substituted or unsubstituted alkyl group having from 1 to 8 carbon atoms, preferably a hydrogen atom.

m2 and n2 each independently represent an integer of 0 or 1.

Specific examples of the cyclic structure represented by the formula (2) or (5) are shown below. However the cyclic structure which can be used in the present invention is not limited to these specific examples below.

### Examples of the Cyclic Structure Represented by Formula (2) or (5):

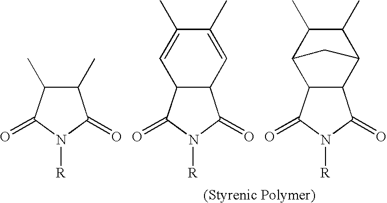

As the polymer having a negative birefringence, styrenic polymers are also preferable.

The styrenic polymers preferably have the structural units derived from aromatic vinylic monomers represented by the following formula (A):

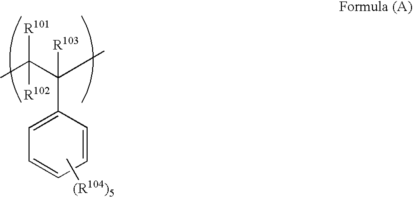

wherein R¹⁰¹ to R¹⁰⁴ each independently represent a hydrogen atom, a halogen atom, or a substituted or unsubstituted hydrocarbon group having from 1 to 30 carbon atoms and optionally having a linking group containing an oxygen atom, a sulfur atom, a nitrogen atom or a silicon atom, or a polar group; R¹⁰⁴'s may be all the same atoms or groups, or may be different atoms or groups, and they may bond to each other to form a carbon ring or a hetero ring (the carbon ring or the hetero ring may have a monocyclic structure or may have a polycyclic structure condensed with any other ring).

Specific examples of the aromatic vinylic monomer include styrene; alkyl-substituted styrenes such as α-methylstyrene, β-methylstyrene, o-methylstyrene, m-methylstyrene, p-methylstyrene; halogen-substituted styrenes such as 4-chlorostyrene, 4-bromostyrene; hydroxystyrenes such as o-hydroxystyrene, m-hydroxystyrene, p-hydroxystyrene, α-methyl-p-hydroxystyrene, 2-methyl-4-hydroxystyrene, 3,4-dihydroxystyrene; vinylbenzyl alcohols; alkoxy-substituted styrenes such as p-methoxystyrene, p-tert-butoxystyrene, m-tert-butoxystyrene; vinylbenzoic acids such as 3-vinylbenzoic acid, 4-vinylbenzoic acid; vinylbenzoates such as methyl 4-vinylbenzoate, ethyl 4-vinylbenzoate; 4-vinylbenzyl acetate; 4-acetoxystyrene; amidestyrenes such as 2-butylamidostyrene, 4-methylamidestyrene, p-sulfonamidestyrene; aminostyrenes such as 3-aminostyrene, 4-aminostyrene, 2-isopropenylaniline, vinylbenzyldimethylamine; nitrostyrenes such as 3-nitrostyrene, 4-nitrostyrene; cyanostyrenes such as 3-cyanostyrene, 4-cyanostyrene; vinylphenylacetonitrile; arylstyrenes such as phenylstyrene; indenes, etc. However, the invention should not be limited to these examples. Two or more different such monomers may be copolymerized to give copolymers for use herein. Of those, preferred are styrene and α-methylstyrene, from the viewpoint that they are easily available industrially and are inexpensive.

### (Acrylic Polymer)

As the polymer having a negative birefringence, acrylic polymers are also preferable.

The acrylic polymers preferably have the structural units derived from acrylate monomers represented by the following formula (B):

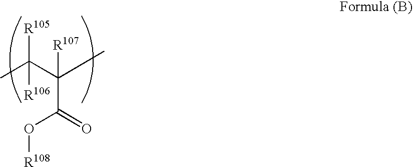

wherein R¹⁰⁵ to R¹⁰⁸ each independently represent a hydrogen atom, a halogen atom, or a substituted or unsubstituted hydrocarbon group having from 1 to 30 carbon atoms optionally having a linking group containing an oxygen atom, a sulfur atom, a nitrogen atom or a silicon atom, or a polar group.

Examples of the acrylate monomers include, for example, methyl acrylate, ethyl acrylate, (i-, n-)propyl acrylate, (n-, i-, s-, tert-)butylacrylate, (n-, i-, s-)pentylacrylate, (n-, i-)hexyl acrylate, (n-, 1-)heptyl acrylate, (n-, i-)octyl acrylate, (n-, i-)nonyl acrylate, (n-, i-)myristyl acrylate, (2-ethylhexyl) acrylate, (ε-caprolactone) acrylate, (2-hydroxyethyl) acrylate, (2-hydroxypropyl) acrylate, (3-hydroxypropyl acrylate, (4-hydroxybutyl) acrylate, (2-hydroxybutyl) acrylate, (2-methoxyethyl) acrylate, (2-ethoxyethyl) acrylate, phenyl acrylate, phenyl methacrylate, (2 or 4-chlorophenyl) acrylate, (2 or 4-chlorophenyl) methacrylate, (2 or 3 or 4-ethoxycarbonylphenyl) acrylate, (2 or 3 or 4-ethoxycarbonylphenyl) methacrylate, (o or m or p-tolyl) acrylate, (o or m or p-tolyl) methacrylate, benzyl acrylate, benzyl methacrylate, phenethyl acrylate, phenethyl methacrylate, (2-naphthyl) acrylate, cyclohexyl acrylate, cyclohexyl methacrylate, (4-methylcyclohexyl) acrylate, (4-methylcyclohexyl) methacrylate, (4-ethylcyclohexyl) acrylate, (4-ethylcyclohexyl) methacrylate, and methacrylates corresponding to the above-mentioned acrylates. However, the invention should not be limited to these examples. Two or more such monomers may be copolymerized into copolymers for use herein. Of those, preferred are methyl acrylate, ethyl acrylate, (i-, n-)propyl acrylate, (n-, i-, s-, tert-)butyl acrylate, (n-, i-, s-) pentyl acrylate, (n-, i-)hexyl acrylate, and methacrylates corresponding to these acrylates, from the viewpoint that they are easily available industrially and are inexpensive.

### (Copolymer)

Not overstepping the scope and the sprit of the invention, the polymer having a negative birefringence in the invention may be a copolymer. In case where the polymer having a negative birefringence is a copolymer, it may be a block copolymer or a random copolymer. It may also be a grafted copolymer.

The polymer having a cyclic structure represented by formula (1) or (2) in the side branch may be a homopolymer of a monomer having a cyclic structure represented by formula (1) or (2) in the side branch, a copolymer of at least two monomers having a cyclic structure represented by formula (1) or (2) in the side branch, or a copolymer of a monomer having a cyclic structure represented by (1) or (2) in the branch and any other monomer.

Said other monomers are not specifically defined. For example, they include acrylic acid, methacrylic acid, alkyl acrylate (e.g., methyl acrylate, ethyl acrylate), alkyl methacrylate (e.g., methyl methacrylate, ethyl methacrylate), aminoalkyl acrylate (e.g., diethylaminoethyl acrylate), aminoalkyl methacrylate, monoester of acrylic acid and glycol, monoester of methacrylic acid and glycol (e.g., hydroxyethyl methacrylate), alkali metal salt of acrylic acid, alkali metal salt of methacrylic acid, ammonium salt of acrylic acid, ammonium salt of methacrylic acid, quaternary ammonium derivative of aminoalkyl acrylate, quaternary ammonium derivative of aminoalkyl methacrylate, quaternary ammonium compound of diethylaminoethyl acrylate and methyl sulfate, vinyl methyl ether, vinyl ethyl ether, alkali metal salt of vinylsulfonic acid, ammonium salt of vinylsulfonic acid, styrenesulfonic acid, styrenesulfonic acid salt, allylsulfonic acid, allylsulfonic acid salt, methallylsulfonic acid, methallylsulfonic acid salt, vinyl acetate, vinyl stearate, N-vinylimidazole, N-vinylacetamide, N-vinylformamide, N-vinylcaprolactam, N-vinylcarbazole, acrylamide, methacrylamide, N-alkylacrylamide, N-methylolacrylamide, N,N-methylenebisacrylamide, glycol diacrylate, glycol dimethacrylate, divinylbenzene, glycol diallyl ether, etc. Of those, preferred are vinyl acetate, acrylic acid, methacrylic acid, and methyl acrylate, more preferred are vinyl acetate and methyl acrylate, particularly preferred is vinyl acetate.

In case where the degree of acyl substitution in the cellulose acylate resin is high, the hydrophobicity of the cellulose acylate resin is high; and therefore, it is desirable that the polymer is a copolymer of a monomer having a cyclic structure represented by formula (1) or (2) in the side branch and any other monomer so that the copolymer may have an increased degree of hydrophobicity and the compatibility of the copolymer with the resin is thereby enhanced. On the contrary, when the degree of acyl substitution in the cellulose acylate resin is low, the hydrophobicity of the cellulose acylate resin is low; and therefore, it is desirable that the polymer is a copolymer of a monomer having a cyclic structure represented by formula (1) or (2) in the side branch and any other monomer so that the copolymer may have a decreased degree of hydrophobicity and the compatibility of the copolymer with the resin is thereby enhanced. For example, when a vinylpyrrolidone homopolymer is used as the copolymer having a cyclic structure represented by formula (1) or (2) in the side branch, the vinylpyrrolidone homopolymer is hydrophilic and therefore its compatibility with a cellulose acylate resin having a high degree of acyl substitution. Accordingly, for example, a copolymer of polyvinylpyrrolidone and polyvinyl acetate is formed and its copolymerization ratio is suitably controlled, whereby the hydrophilicity/hydrophobicity of the thus-constructed copolymer may be suitably controlled in accordance with the degree of acyl substitution of the cellulose acylate resin. Thus controlling the compatibility of the two in the manner as above is preferred as capable of preventing the cellulose acylate film to be formed from being bled or whitened.

In the copolymer of a monomer having a cyclic structure represented by formula (1) or (2) in the side branch and another monomer, the copolymerization ratio of the monomer having a cyclic structure represented by formula (1) or (2) in the side branch to the other monomer is preferably from 3/7 to 9/1, more preferably from 3/7 to 7/3, even more preferably from 5/5 to 7/3.

In case where the polymer having a negative birefringence is a copolymer, the copolymer preferably includes at least one kind of a structural unit derived from an aromatic vinyl monomer represented by the following formula (A) and one kind of a structural unit derived from an acrylic ester monomer, represented by the following formula (B):

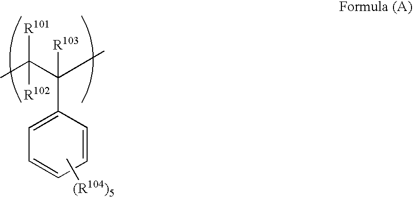

wherein R¹⁰¹ to R¹⁰⁴ each independently represent a hydrogen atom, a halogen atom, or a substituted or unsubstituted hydrocarbon group having from 1 to 30 carbon atoms and optionally having a linking group containing an oxygen atom, a sulfur atom, a nitrogen atom or a silicon atom, or a polar group; R¹⁰⁴'s may be all the same atoms or groups, or may be different atoms or groups, and they may bond to each other to form a carbon ring or a hetero ring (the carbon ring or the hetero ring may have a monocyclic structure or may have a polycyclic structure condensed with any other ring).

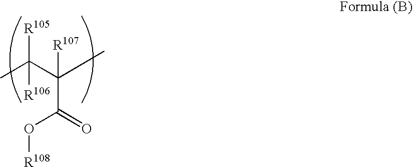

wherein R¹⁰⁵ to R¹⁰⁸ each independently represent a hydrogen atom, a halogen atom, or a substituted or unsubstituted hydrocarbon group having from 1 to 30 carbon atoms optionally having a linking group containing an oxygen atom, a sulfur atom, a nitrogen atom or a silicon atom, or a polar group.

As the other structure than the above to constitute the copolymer composition, preferred are those excellent in the copolymerizability with the above-mentioned monomers, and their examples include acid anhydrides such as maleic anhydride, citraconic anhydride, cis-1-cyclohexene-1,2-dicarboxylic acid anhydride, 3-methyl-cis-1-cyclohexene-1,2-dicarboxylic acid anhydride, 4-methyl-cis-1-cyclohexene-1,2-dicarboxylic acid anhydride; nitrile group-containing radical-polymerizable monomers such as acrylonitrile, methacrylonitrile; amide bond-containing radical-polymerizable monomers such as acrylamide, methacrylamide, trifluoromethanesulfonylaminomethyl (meth)acrylate; aliphatic vinyls such as vinyl acetate; chlorine-containing radical-polymerizable monomers such as vinyl chloride, vinylidene chloride; conjugated diolefins such as 1,3-butadiene, isoprene, 1,4-dimethylbutadiene, etc. However, the invention should not be limited to these examples. Of those, especially preferred are styrene/acrylic acid copolymers, styrene/maleic anhydride copolymers and styrene/acrylonitrile copolymers.

### <Needle-Like Particles>

The needle-like particles having a negative birefringence include at least one type of needle-like particles having a negative birefringence in the stretching direction. Not specifically defined, the needle-like particles having a negative birefringence in the stretching direction include needle-like inorganic particles and needle-like polymer particles. The needle-like particles have a negative birefringence in the alignment direction. For example, strontium carbonate crystal particles are needle-like (rod-shaped) particles, and therefore, when kept under stress while dispersed in a viscous medium, the particles can be aligned statistically in a predetermined direction.

As the needle-like inorganic particles, usable are birefringent particles described in JP-A 2004-109355. For example, they include various carbonates such as calcium carbonate, strontium carbonate, magnesium carbonate, manganese carbonate, cobalt carbonate, zinc carbonate, barium carbonate, etc. Preferably, these carbonates are tetragonal system, hexagonal system, rhombohedral system or the like monoaxial birefringent crystals, or orthorhombic system, monoclinic system or triclinic system crystals. These may be single crystals or polycrystals.

As the needle-like polymer particles, preferred are polystyrene or acrylic resin rod-shaped crystals. For example, they may be short fiber-like needle-like crystals produced by finely cutting polystyrene resin or acrylic resin ultrafine fibers. Preferably, these fibers are stretched during their production as capable of readily expressing birefringence. Also preferably, these resins are crosslinked.

The birefringence of the above-mentioned birefringent needle-like crystals is defined as follows: The refractive index of the birefringent particles to the light polarized in the major diameter direction of the particles is represented by npr, and the mean refractive index thereof to the light polarized in the direction perpendicular to the major diameter direction is by nvt. The birefringence Δn of the birefringent particles is defined by Δn=npr−nvt.

Accordingly, when the refractive index of the birefringent particles in the major diameter direction thereof is larger than the mean refractive index in the direction perpendicular to the major diameter direction thereof, then the particles have a positive birefringence, and the birefringent particles contrary to them have a negative birefringence.

### (Amount of Addition)

The amount of the compound having a negative birefringence to be added is preferably from 0.5 to 40 parts by mass relative to 100 parts by mass of the cellulose acylate resin, more preferably from 0.5 to 30 parts by mass, even more preferably from 1 to 20 parts by mass.

### (Weight-Average Molecular Weight)

In case where the compound having a negative birefringence is a polymer having a negative birefringence, the weight-average molecular weight of the polymer having a negative birefringence is preferably from 500 to 100,000, more preferably from 700 to 50,000, particularly preferably from 1,000 to 25,000.

Having a molecular weight of at least 500, the evaporative of the polymer having a negative birefringence is low and it is preferable; while having a molecular weight of at most 100,000, the miscibility of the polymer having a negative birefringence with cellulose acylate resin is be good which makes productivity of the cellulose acylate film good; and both are favorable.

### [Additives]

### (Retardation Enhancer)

In the invention, a retardation enhancer may be added or not. The retardation enhancer is preferably added to the film for making the film have a preferable retardation. The retardation enhancer for use in the invention includes rod-shaped compounds, discotic compounds and compounds having a positive birefringence. Of the rod-shaped or discotic compounds, those having at least two aromatic groups are preferred for use as the retardation enhancer in the invention.

The amount of the retardation enhancer of a rod-shaped compound to be added is preferably from 0.1 to 30 parts by mass relative to 100 parts by mass of the cellulose acylate-containing polymer ingredient, more preferably from 0.5 to 20 parts by mass.

Preferably, the amount of a discotic retardation enhancer to be added is preferably from 0.05 to 20 parts by mass relative to 100 parts by mass of the cellulose acylate resin, more preferably from 1.0 to 15 parts by mass, even more preferably from 3.0 to 10 parts by mass.

A discotic compound is superior to a rod-shaped compound as an Rth retardation enhancer, and is therefore favorably used in ace where the film requires an especially large Rth retardation. Two or more different types of retardation enhancers may be used, as combined.

Preferably, the retardation enhancer has a maximum absorption in a wavelength range of from 250 to 400 nm, and preferably, it does not have substantial absorption in a visible light region.

### (1) Discotic Compound

Description will be given about the discotic compound. As the discotic compound, a compound having at least two aromatic rings can be employed.

In the specification, an “aromatic ring” includes an aromatic heteroring, in addition to an aromatic hydrocarbon ring.

The aromatic hydrocarbon ring is particularly preferably a 6-membered ring (that is, benzene ring). Generally, the aromatic heteroring is an unsaturated heteroring. The aromatic heteroring is preferably a 5-membered ring, 6-membered ring or a 7-membered ring, more preferably a 5-membered ring or a 6-membered ring. Generally, the aromatic heteroring has the largest number of double bonds. As hetero atoms, a nitrogen atom, an oxygen atom and a sulfur atom are preferred, and a nitrogen atom is particularly preferred. Examples of the aromatic heteroring include a furan ring, a thiophene ring, a pyrrole ring, an oxazole ring, an iso-oxazole ring, a thiazole ring, an iso-thiazole ring, an imidazole ring, a pyrazole ring, a furazane ring, a triazole ring, a pyran ring, a pyridine ring, a pyridazine ring, a pyrimidine ring, a pyrazine ring and a 1,3,5-triazine ring.

As the aromatic ring, a benzene ring, a condensed benzene ring, biphenol and a 1,3,5-triazine ring are used preferably, and, in particular, a 1,3,5-triazine ring is preferably used. Specifically, compounds, for example, disclosed in JP-A-2001-166144 are used preferably as a discotic compound.

Number of carbon atoms of the aromatic rings included in the retardation enhancer is preferably 2-20, more preferably 2-12, furthermore preferably 2-8, most preferably 2-6.

Bond relation of two aromatic rings can be classified into following cases (since an aromatic ring, a spiro bond can not be formed): (a) formation of a condensed ring, (b) formation of a direct bond by a single bond, and (c) formation of a bond via a linking group. The bond relation may be any one of (a)-(c).

Examples of the (a) condensed ring (a condensed ring of two or more of aromatic rings) include an indene ring, a naphthalene ring, an azulene ring, a fluorene ring, a phenanthrene ring, an anthracene ring, an acenaphthylene ring, an biphenylene ring, a naphthacene ring, a pyrene ring, an indole ring, an iso-indole ring, a benzofuran ring, a benzothiophene ring, an indolizine ring, a benzoxazole ring, a benzothiazole ring, a benzoimidazole ring, a benzotriazole ring, a purine ring, an indazole ring, a chromene ring, a quinoline ring, an isoquinoline ring, a quinolizine ring, a quinazoline ring, a cinnoline ring, a quinoxaline ring, a phthalazine ring, a pteridine ring, a carbazole ring, an acridine ring, a phenanthridine ring, a xanthene ring, a phenazine ring, a phenothiazine ring, a phenoxthine ring, a phenoxazine ring and a thianthrene ring. A naphthalene ring, an azulene ring, an indole ring, a benzoxazole ring, a benzothiazole ring, a benzoimidazole ring, benzotriazole ring and a quinoline ring are preferred.

The single bond of (b) is preferably a carbon-carbon bond between two aromatic rings. Two aromatic rings may be bonded by two or more of single bonds to form an aliphatic ring or a non-aromatic heteroring between the two aromatic rings.

The linking group of (c) also bonds, preferably, to carbon atoms of the two aromatic rings. The linking group is preferably an alkylene group, an alkenylene group, an alkynylene group, —CO—, —O—, —NH—, —S— or combinations thereof. Examples of the linking group composed of the combination are shown below. In this connection, the relation of right and left in the following examples of linking group may be reversed.

c1: —CO—O—
c2: —CO—NH—
c3: -alkylene-O—
c4: —NH—CO—NH—
c5: —NH—CO—O—
c6: —O—CO—O—
c7: —O-alkylene-O—
c8: —CO-alkenylene-
c9: —CO-alkenylene-NH—
c10: —CO-alkenylene-O—
c11: -alkylene-CO—O-alkylene-O—CO-alkylene-
c12: —O-alkylene-CO—O-alkylene-O—CO-alkylene-O—
c13: —O—CO-alkylene-CO—O—
c14: —NH—CO-alkenylene-
c15: —O—CO-alkenylene-

The aromatic ring and the linking group may have a substituent.

Examples of the substituent include a halogen atom (F, Cl, Br, I), a hydroxyl group, a carboxyl group, a cyano group, an amino group, a nitro group, a sulfo group, a carbamoyl group, a sulfamoyl group, an ureide group, an alkyl group, an alkenyl group, an alkynyl group, an aliphatic acyl group, an aliphatic acyloxy group, an alkoxy group, an alkoxycarbonyl group, an alkoxycarbonylamino group, an alkylthio group, an alkylsulfonyl group, an aliphatic amide group, an aliphatic sulfonamide group, an aliphatic-substituted amino group, an aliphatic-substituted carbamoyl group, an aliphatic-substituted sulfamoyl group, an aliphatic-substituted ureide group and a non-aromatic heterocyclic group.

Number of carbon atoms of the alkyl group is preferably 1-8. A chain alkyl group is preferred to a cyclic alkyl group, and a strait-chain alkyl group is particularly preferred. The alkyl group may further have a substituent (for example, a hydroxyl group, a carboxyl group, an alkoxy group, an alkyl-substituted amino group). Examples of the alkyl group (including the substituted alkyl group) include a methyl group, an ethyl group, a n-butyl group, a n-hexyl group, a 2-hydroxyethyl group, a 4-carboxybutyl group, a 2-methoxyethyl group and 2-diethylaminoethyl group.

Number of carbon atoms of the alkenyl group is preferably 2-8. A chain alkenyl group is preferred to a cyclic alkenyl group, and a straight-chain alkenyl group is particularly preferred. The alkenyl group may further have a substituent. Examples of the alkenyl group include a vinyl group, an aryl group and a 1-hexenyl group.

Number of carbon atoms of the alkynyl group is preferably 2-8. A chain alkynyl group is preferred to a cyclic alkynyl group, and a straight-chain alkynyl group is particularly preferred. The alkynyl group may further have a substituent. Examples of the alkynyl group include an ethynyl group, a 1-butynyl group and a 1-hexynyl group.

Number of carbon atoms of the aliphatic acyl group is preferably 1-10. Examples of the aliphatic acyl group include an acetyl group, a propanoyl group and a butanoyl group.

Number of carbon atoms of the aliphatic acyloxy group is preferably 1-10. Example of the aliphatic acyloxy group include an acetoxy group.

Number of carbon atoms of the alkoxy group is preferably 1-8. The alkoxy group may further have an substituent (for example, an alkoxy group). Examples of the alkoxy group (including a substituted alkoxy group) include a methoxy group, an ethoxy group, a butoxy group and a methoxyethoxy group.

Number of carbon atoms of the alkoxycarbonyl group is preferably 2-10. Examples of the alkoxycarbonyl group include a methoxycarbonyl group and an ethoxycarbonyl group.

Number of carbon atoms of the alkoxycarbonylamino group is preferably 2-10. Examples of the alkoxycarbonylamino group include a methoxycarbonylamino group and an ethoxycarbonylamino group.

Number of carbon atoms of the alkylthio group is preferably 1-12. Examples of the alkylthio group include a methylthio group, an ethylthio group and an octylthio group.

Number of carbon atoms of the alkylsulfonyl group is preferably 1-8. Examples of the alkylsulfonyl group include a methanesulfonyl group and an ethanesulfonyl group.

Number of carbon atoms of the aliphatic amide group is preferably 1-10. Example of the aliphatic amide group includes an acetamide group.

Number of carbon atoms of the aliphatic sulfonamido group is preferably 1-8. Examples of the aliphatic sulfonamido group include a methane sulfonamido group, a butane sulfonamido group and a n-octane sulfonamido group.

Number of carbon atoms of the aliphatic-substituted amino group is preferably 1-10. Examples of the aliphatic-substituted amino group include a dimethylamino group, a diethylamino group and a 2-carboxyethylamino group.

Number of carbon atoms of the aliphatic-substituted carbamoyl group is preferably 2-10. Examples of the aliphatic-substituted carbamoyl group include a methylcarbamoyl group and a diethylcarbamoyl group.

Number of carbon atoms of the aliphatic-substituted sulfamoyl group is preferably 1-8. Examples of the aliphatic-substituted sulfamoyl group include a methylsulfamoyl group and a diethylsulfamoyl group.

Number of carbon atoms of the aliphatic-substituted ureide group is preferably 2-10. Example of the aliphatic-substituted ureide group includes a methylureide group.

Examples of the non-aromatic heterocyclic group include a piperidino group and a morphorino group.

Molecular weight of the retardation enhancer composed of the discotic compound is preferably 300-800.

A compound represented by following formula (I) is preferably used for the discotic compound.

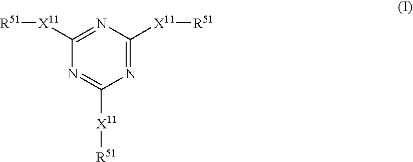

In the above formula (I):

R⁵¹ each independently represents an aromatic group or a heterocyclic group having at least one substituent at any of the ortho-, meta- and para-positions.

X¹¹ each independently represents a single bond or —NR⁵²—. R⁵² each independently represents a hydrogen atom, or a substituted or unsubstituted alkyl, alkenyl, aryl or heterocyclic group.

The aromatic group represented by R⁵¹ is preferably a phenyl ring or a naphthyl ring, particularly preferably a phenyl ring. The aromatic group represented by R⁵¹ may have at least one substituent in any one of substitution positions. For the example of the above-mentioned substituent, a halogen atom, a hydroxyl group, a cyano group, a nitro group, a carboxyl group, an alkyl group, an alkenyl group, an aryl group, an alkoxy group, an alkenyloxy group, an aryloxy group, an acyloxy group, an alkoxycarbonyl group, an alkenyloxycarbonyl group, an aryloxycarbonyl group, a sulfamoyl group, an alkyl substituted sulfamoyl group, an alkenyl substituted sulfamoyl group, an aryl substituted sulfamoyl group, a sulfonamide group, a carbamoyl group, an alkyl substituted carbamoyl group, an alkenyl substituted carbamoyl group, an aryl substituted carbamoyl group, an amide group, an alkylthio group, an alkenylthio group, an arylthio group and an acyl group are included.

The heterocyclic group represented by R⁵¹ is preferably aromatic. The aromatic heterocyclic group is generally an unsaturated heterocyclic group, and is preferably a heterocyclic group having maximum double bonds. The hetero ring of the heterocyclic group is preferably a 5-membered ring, a 6-membered ring or a 7-membered ring, more preferably a 5-membered ring or a 6-membered ring, most preferably a 6-membered ring. The hetero atom constituting the heterocyclic group is preferably a nitrogen atom, a sulfur atom or an oxygen atom, more preferably a nitrogen atom. The aromatic hetero ring is especially preferably a pyridine ring (as the heterocyclic group, a 2-pyridyl or 4-pyridyl group). The heterocyclic group may have a substituent. Examples of the substituent for the heterocyclic group may be the same as those mentioned hereinabove for the substituent of the aromatic group.

The heterocyclic group in a case where X¹¹ is a single bond is preferably a heterocyclic group having a chemical bond at the nitrogen atom. The hetero ring of the heterocyclic group having a chemical bond at the nitrogen atom is preferably a 5-membered ring, a 6-membered ring or a 7-membered ring, more preferably a 5-membered ring or a 6-membered ring, most preferably a 5-membered ring. The heterocyclic group may have plural nitrogen atoms. The heterocyclic group may have any other heteroatom (e.g., O, S) than the nitrogen atom. Examples of the heterocyclic group having a chemical bond at the nitrogen atom are shown below. C₄H₉ⁿ represents normal C₄H₉.

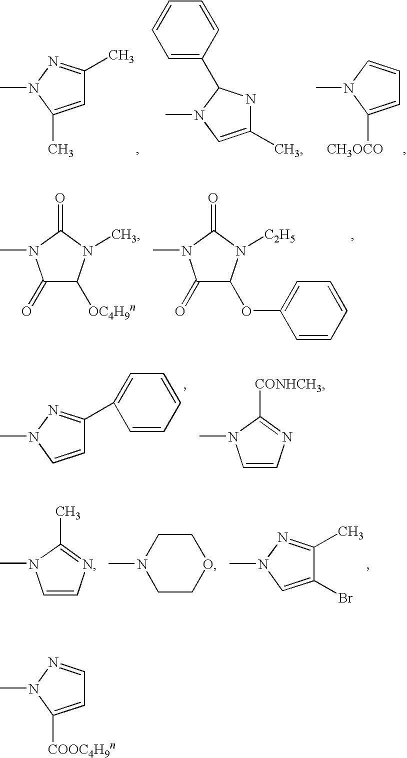

The alkyl group represented by R⁵² may be a cycloalkyl group or a chain alkyl group, preferably a chain alkyl group. A straight chain alkyl group is more preferred to a branched chain alkyl group. Number of the carbon atoms of the alkyl group is preferably 1-30, more preferably 1-20, further preferably 1-10, furthermore preferably 1-8, and most preferably 1-6. The alkyl group may have a substituent. An example of the substituent includes a halogen atom, an alkoxy group (for example, a methoxy group, an ethoxy group) and an acyloxy group (for example, an acryloyloxy group, a methacryloyloxy group).

The alkenyl group represented by R⁵² may be an cyclo alkenyl group or a chain alkenyl group, preferably a chain alkenyl group. A straight chain alkenyl group is more preferred to a branched chain alkyl group. Number of the carbon atoms of the alkyl group is preferably 2-30, more preferably 2-20, further preferably 2-10, further more preferably 2-8, and most preferably 2-6. The alkenyl group may have a substituent. As the substituents, those for the above-mentioned alkyl group can be used.

The aryl group and heterocyclic group represented by R⁵² and their preferable groups are as described in R⁵¹ above. The aryl group and the heterocyclic group may have a substituent further, and examples of the substituent are the same as those for R⁵¹.

As a discotic compound, the triphenylene compound represented by the following formula (II) can also be used preferably.

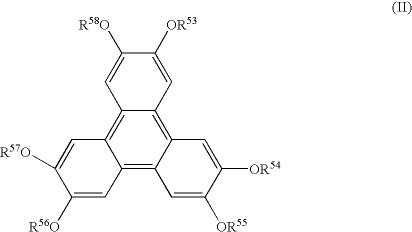

In the formula (II), R⁵³, R⁵⁴, R⁵⁵, R⁵⁶, R⁵⁷ and R⁵⁸ each represent independently a hydrogen atom or a substituent.

Examples of each of the substituent represented by R⁵³, R⁵⁴, R⁵⁵, R⁵⁶, R⁵⁷ and R⁵⁸ include an alkyl group (including, preferably, 1-40 carbon atoms, more preferably 1-30 carbon atoms, particularly preferably 1-20 carbon atoms, such as a methyl group, an ethyl group, an isopropyl group, a tert-butyl group, a n-octyl group, a n-decyl group, a n-hexadecyl group, a cyclopropyl group, a cyclopentyl group and a cyclohexyl group), an alkenyl group (including, preferably, 2-40 carbon atoms, more preferably 2-30 carbon atoms, particularly preferably 2-20 carbon atoms, such as a vinyl group, an allyl group, a 2-butenyl group and a 3-pentenyl group), an alkynyl group (including, preferably, 2-40 carbon atoms, more preferably 2-30 carbon atoms, particularly preferably 2-20 carbon atoms, such as a propargyl group and a 3-pentynyl group), an aryl group (including, preferably, 6-30 carbon atoms, more preferably 6-20 carbon atoms, particularly preferably 6-12 carbon atoms, such as a phenyl group, a p-methylphenyl group and a naphthyl group), substituted or unsubstituted amino group (including, preferably, 0-40 carbon atoms, more preferably 0-30 carbon atoms, particularly preferably 0-20 carbon atoms, such as an unsubstituted amino group, a methylamino group, a dimethylamino group, a diethylamino group and an anilino group), an alkoxy group (including, preferably, 1-40 carbon atoms, more preferably 1-30 carbon atoms, particularly preferably 1-20 carbon atoms, such as a methoxy group, an ethoxy group and a butoxy group), an aryloxy group (including, preferably, 6-40 carbon atoms, more preferably 6-30 carbon atoms, particularly preferably 6-20 carbon atoms, such as a phenyloxy group and a 2-naphthyloxy group), an acyl group (including, preferably, 1-40 carbon atoms, more preferably 1-30 carbon atoms, particularly preferably 1-20 carbon atoms, such as an acetyl group, a benzoyl group, a formyl group and a pivaloyl group), an alkoxycarbonyl group (including, preferably, 2-40 carbon atoms, more preferably 2-30 carbon atoms, particularly preferably 2-20 carbon atoms, such as a methoxycarbonyl group and an ethoxycarbonyl group), an aryloxycarbonyl group (including, preferably, 7-40 carbon atoms, more preferably 7-30 carbon atoms, and particularly preferably 7-20 carbon atoms, such as a phenyloxycarbonyl group), an acyloxy group (including, preferably, 2-40 carbon atoms, more preferably 2-30 carbon atoms, particularly preferably 2-20 carbon atoms, such as an acetoxy group and a benzoyloxy group), an acylamino group (including, preferably, 2-40 carbon atoms, more preferably 2-30 carbon atoms, particularly preferably 2-20 carbon atoms, such as an acetylamino group and a benzoylamino group), an alkoxycarbonylamino group (including, preferably, 2-40 carbon atoms, more preferably 2-30 carbon atoms, particularly preferably 2-20 carbon atoms, such as a methoxycarbonylamino group), an aryloxycarbonylamino group (including, preferably, 7-40 carbon atoms, more preferably 7-30 carbon atoms, and particularly preferably 7-20 carbon atoms, such as a phenyloxycarbonylamino group), a sulfonylamino group (including, preferably, 1-40 carbon atoms, more preferably 1-30 carbon atoms, particularly preferably 1-20 carbon atoms, such as a methanesulfonylamino group and a benzenesulfonylamino group), a sulfamoyl group (including, preferably, 0-40 carbon atoms, more preferably 0-30 carbon atoms, particularly preferably 0-20 carbon atoms, such as a sulfamoyl group, a methylsulfamoyl group, a dimethylsulfamoyl group and a phenylsulfamoyl group), a carbamoyl group (including, preferably, 1-40 carbon atoms, more preferably 1-30 carbon atoms, particularly preferably 1-20 carbon atoms, such as an unsubstituted carbamoyl group, a methylcarbamoyl group, a diethylcarbamoyl group and a phenylcarbamoyl group), an alkylthio group (including, preferably, 1-40 carbon atoms, more preferably 1-30 carbon atoms, particularly preferably 1-20 carbon atoms, such as a methylthio group, an ethylthio group, propylthio group, butylthio group, pentylthio group, hexylthio group, heptylthio group and octylthio group), an arylthio group (including, preferably, 6-40 carbon atoms, more preferably 6-30 carbon atoms, particularly preferably 6-20 carbon atoms, such as a phenylthio group), a sulfonyl group (including, preferably, 1-40 carbon atoms, more preferably 1-30 carbon atoms, particularly preferably 1-20 carbon atoms, such as a mesyl group and a tosyl group), a sulfinyl group (including, preferably, 1-40 carbon atoms, more preferably 1-30 carbon atoms, particularly preferably 1-20 carbon atoms, such as a methanesulfinyl group and a benzenesulfinyl group), an ureide group (including, preferably, 1-40 carbon atoms, more preferably 1-30 carbon atoms, particularly preferably 1-20 carbon atoms, such as an unsubstituted ureide group, a methylureide group and a phenylureide group), a phosphoric amide group (including, preferably, 1-40 carbon atoms, more preferably 1-30 carbon atoms, particularly preferably 1-20 carbon atoms, such as a diethylphosphoric amide group and a phenylphosphoric amide group), a hydroxyl group, a mercapto group, a halogen atom (such as a fluorine atom, a chlorine atom, a bromine atom, an iodine atom), a cyano group, a sulfo group, a carboxyl group, a nitro group, a hydroxamic acid group, a sulfino group, a hydrazino group, an imino group, a heterocyclic group (including, preferably, 1-30 carbon atoms, more preferably 1-12 carbon atoms, wherein examples of the hetero atom include a nitrogen atom, an oxygen atom and a sulfur atom, and specific examples include an imidazolyl group, a pyridyl group, a quinolyl group, a furyl group, a piperidyl group, a morphorino group, a benzoxysazolyl group, a benzimidazolyl group, a benzothiazolyl group and 1,3,5-triazyl group), and a silyl group (including, preferably, 3-40 carbon atoms, more preferably 3-30 carbon atoms, particularly preferably 3-24 carbon atoms, such as a trimethylsilyl group and a triphenylsilyl group). These substituents may further have a substituent. When there are two substituents or more, they may be same with or different from each other. Further, when possible, they may be linked with each other to form a ring.

As the substituent represented by R⁵³, R⁵⁴, R⁵⁵, R⁵⁶, R⁵⁷ and R⁵⁸ is preferably an alkyl group, an aryl group, a substituted or unsubstituted amino group, an alkoxy group, an alkylthio group or a halogen atoms.

Preferable examples of the compound represented by the formula (II) are shown below, however compounds usable in the invention are not restricted to these specific examples.

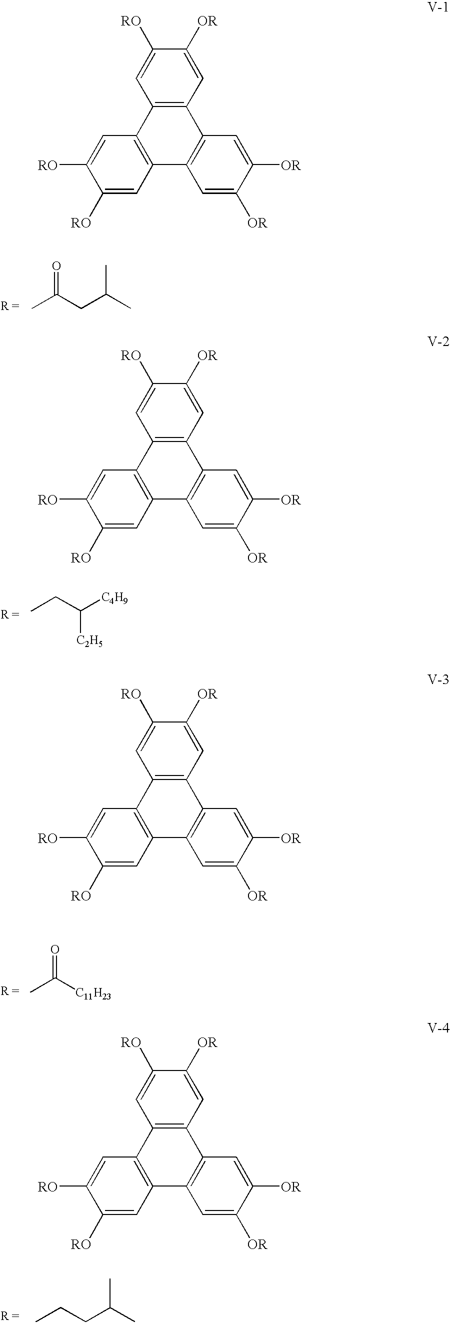

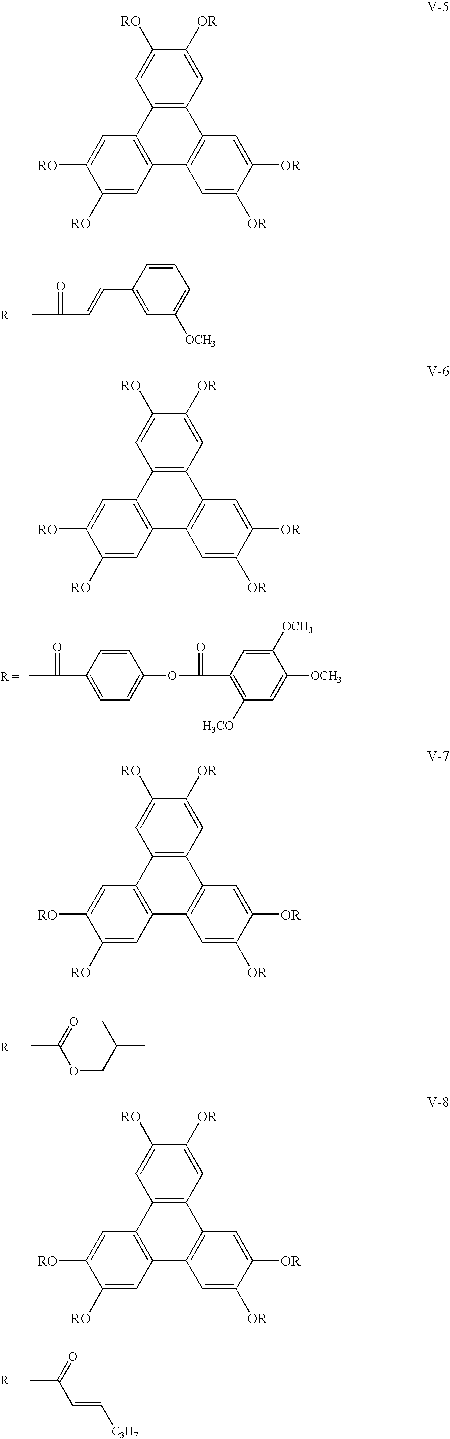

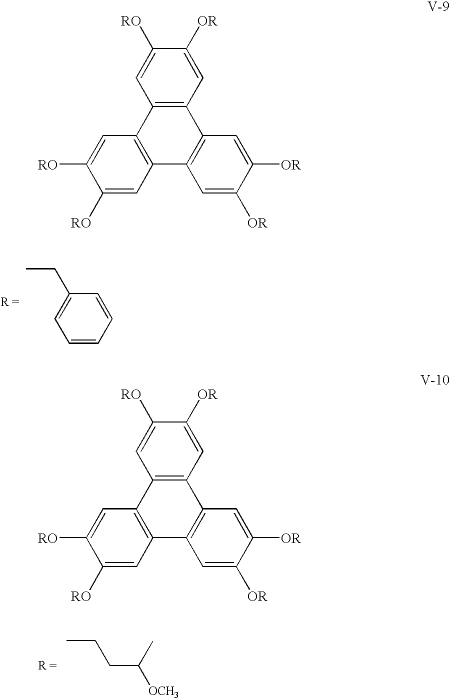

The compound represented by formula (I) can be produced by, for example, a method given in the JP-A 2003-344655 and the compound represented by formula (II) can be produced by, for example, a method given in JP-A 2005-134884. Both compounds may be produced by other well-known methods.

### (2) Rod-Shaped Compound

In the invention, rod-shaped compounds having a linear molecular structure are also usable preferably in addition to the discotic compound. “The linear molecular structure” means that molecular structure of a rod-shaped compound is linear in the thermodynamically stablest structure. The thermodynamically stablest structure can be obtained by crystal structure analysis or molecular orbital calculation. For example, molecular orbital calculation can be performed using a software for molecular orbital calculation (for example, WinMOPAC2000, manufactured by FUJITSU) to obtain the molecular structure for which heat of formation of the compound becomes least. “The linear molecular structure” means that the angle constituted by the primary chain of the molecular structure is 140 degrees or more in the thermodynamically stablest structure obtained according to the aforementioned calculation.

As the rod-shaped compound having at least two aromatic rings, compounds represented by formula (III) below are preferred.

Ar¹-L¹¹-Ar²: Formula (III)

wherein each of Ar¹ and Ar² represents an aromatic group independently from each other.

In the specification, the aromatic group includes an aryl group (aromatic hydrocarbon group), a substituted aryl group, an aromatic heterocyclic group and a substituted aromatic heterocyclic group.

An aryl group and a substituted aryl group are preferred to an aromatic heterocyclic group and a substituted aromatic heterocyclic group. A heteroring in the aromatic heterocyclic group is generally unsaturated. The hetero ring of the aromatic heterocyclic group is preferably a 5-membered ring, a 6-membered ring or a 7-membered ring, more preferably a 5-membered ring or a 6-membered ring. The aromatic heterocyclic group generally has the largest number of double bonds. As for the hetero atom, a nitrogen atom, an oxygen atom or a sulfur atom is preferred, and a nitrogen atom or a sulfur atom is more preferred.

Preferable examples of the aromatic ring in the aromatic group include a benzene ring, a furan ring, a thiophene ring, a pyrrole ring, an oxazole ring, a thiazole ring, an imidazole ring, a triazole ring, a pyridine ring, a pyrimidine ring and a pyrazine ring. A benzene ring is particularly preferred.

Examples of the substituent of the substituted aryl group and substituted aromatic heterocyclic group include a halogen atom (F, Cl, Br, I), a hydroxyl group, a carboxyl group, a cyano group, an amino group, an alkylamino group (for example, a methylamino group, an ethylamino group, a butylamino group, a dimethylamino group), a nitro group, a sulfo group, a carbamoyl group, an alkylcarbamoyl group (for example, an N-methylcarbamoyl group, an N-ethylcarbamoyl group, an N,N-dimethylcarbamoyl group), a sulfamoyl group, an alkylsulfamoyl group (for example, an N-methylsulfamoyl group, an N-ethylsulfamoyl group, an N,N-dimethylsulfamoyl group), an ureide group, an alkylureide group (for example, an N-methylureide group, an N,N-dimethylureide group, an N,N,N′-trimethylureide group), an alkyl group (for example, a methyl group, an ethyl group, a propyl group, a butyl group, a pentyl group, a heptyl group, an octyl group, an isopropyl group, a s-butyl group, a tert-amyl group, a cyclohexyl group, a cyclopentyl group), an alkenyl group (for example, a vinyl group, an allyl group, a hexenyl group), an alkynyl group (for example, an ethynyl group, a butynyl group), an acyl group (for example, a formyl group, an acetyl group, a butyryl group, a hexanoyl group, a lauryl group), an acyloxy group (for example, an acetoxy group, a butylyloxy group, a hexanoyloxy group, a lauryloxy group), an acylamino group, an alkoxy group (for example, a methoxy group, an ethoxy group, a propoxy group, a butoxy group, a pentyloxy group, a heptyloxy group, an octyloxy group), an aryloxy group (for example, a phenoxy group), an alkoxycarbonyl group (for example, a methoxycarbonyl group, an ethoxycarbonyl group, a propoxycarbonyl group, a butoxycarbonyl group, a pentyloxycarbonyl group, a heptyloxycarbonyl group), an aryloxycarbonyl group (for example, a phenoxycarbonyl group), an alkoxycarbonylamino group (for example, a butoxycarbonylamino group, a hexyloxycarbonylamino group), an alkylthio group (for example, a methylthio group, an ethylthio group, a propylthio group, a butylthio group, a pentylthio group, a heptylthio group, an octylthio group), an arylthio group (for example, phenylthio group), an alkylsulfonyl group (for example, a methylsulfonyl group, an ethylsulfonyl group, a propylsulfonyl group, a butylsulfonyl group, a pentylsulfonyl group, a heptylsulfonyl group, an octylsulfonyl group), an amide group (for example, an acetamide group, a butylamide group, a hexylamide group, a laurylamide group) and non-aromatic heterocyclic groups (for example, a morphoryl group, a pyrazinyl group).

Preferable examples of the substituent of the substituted aryl group and substituted aromatic heterocyclic group include a halogen atom, a cyano group, a carboxyl group, a hydroxyl group, an amino group, an alkylamino group, an acyl group, an acyloxy group, an amide group, an alkoxycarbonyl group, an alkoxy group, an alkylthio group and an alkyl group.

An alkyl moiety in the alkylamino group, the alkoxycarbonyl group, the alkoxy group and the alkylthio group and the alkyl group may further have a substituent. Examples of the substituent in the alkyl moiety and the alkyl group include a halogen atom, a hydroxyl group, a carboxyl group, a cyano group, an amino group, an alkylamino group, a nitro group, a sulfo group, a carbamoyl group, an alkylcarbamoyl group, a sulfamoyl group, an alkylsulfamoyl group, an ureide group, an alkylureide group, an alkenyl group, an alkynyl group, an acyl group, an acyloxy group, an acyloxy group, an acylamino group, an alkoxy group, an aryloxy group, an alkoxycarbonyl group, an ayrloxycarbonyl group, an alkoxycarbonylamino group, an alkylthio group, an arylthio group, an alkylsulfonyl group, an amide group and non-aromatic heterocyclic groups. As the substituent in the alkyl moiety and the alkyl group, a halogen atom, a hydroxyl group, an amino group, an alkylamino group, an acyl group, an acyloxy group, an acylamino group, an alkoxycarbonyl group and an alkoxy group are preferred.

In the formula (III), L¹¹ represents a divalent linking group selected from an alkylene group, an alkenylene group, an alkynylene group, —O—, —CO— and groups composed of combinations thereof.

The alkylene group may have a cyclic structure. As a cyclic alkylene group, cicrohexylene is preferred, and 1,4-cyclohexylene is particularly preferred. As a chain alkylene group, a straight-chain alkylene group is preferred to a branched alkylene group.

Number of carbon atoms of the alkylene group is preferably 1-20, more preferably 1-15, further preferably 1-10, furthermore preferably 1-8, most preferably 1-6.

The alkenylene group and the alkynylene group preferably have a chain structure compared with a cyclic structure, more preferably a straight chain structure compared with a branched chain structure.

Number of carbon atoms of the alkenylene group and the alkynylene group is preferably 2-10, more preferably 2-8, further preferably 2-6, furthermore preferably 2-4, most preferably 2 (that is, vinylene or ethynylene).

Number of carbon atoms of the arylene group is preferably 6-20, more preferably 6-16, further preferably 6-12.

In the molecular structure of the formula (III), an angle formed by Ar¹ and Ar² across L¹¹ is preferably 140 degrees or more.

As the rod-shaped compound, compounds represented by formula (IV) below are more preferred.

Ar¹-L¹²-X-L¹³-Ar²: Formula (IV)

wherein each of Ar¹ and Ar² represents an aromatic group independently from each other. The definition and example for the aromatic group are the same as those for Ar¹ and Ar² of the formula (III).

In the formula (IV), each of L¹² and L¹³ represents, independently from each other, a divalent linking group selected from an alkylene group, —O—, —CO— and groups composed of combinations thereof.

The alkylene group preferably has a chain structure compared with a cyclic structure, and more preferably has a straight chain structure compared with a branched chain structure.

Number of carbon atoms of the alkylene group is preferably 1-10, more preferably 1-8, further preferably 1-6, furthermore preferably 1-4, most preferably 1 or 2 (that is, methylene or ethylene).

Particularly preferably, L¹² and L¹³ are —O—CO— or —CO—O—.

In the formula (IV), X is 1,4-cyclohexylene, vinylene or ethynylene.

As specific examples of the compounds of formula (III) or (IV), mentioned are the compounds of [Formula 1] to [Formula 11] in JP-A 2004-109657.

Preferred examples are shown below.

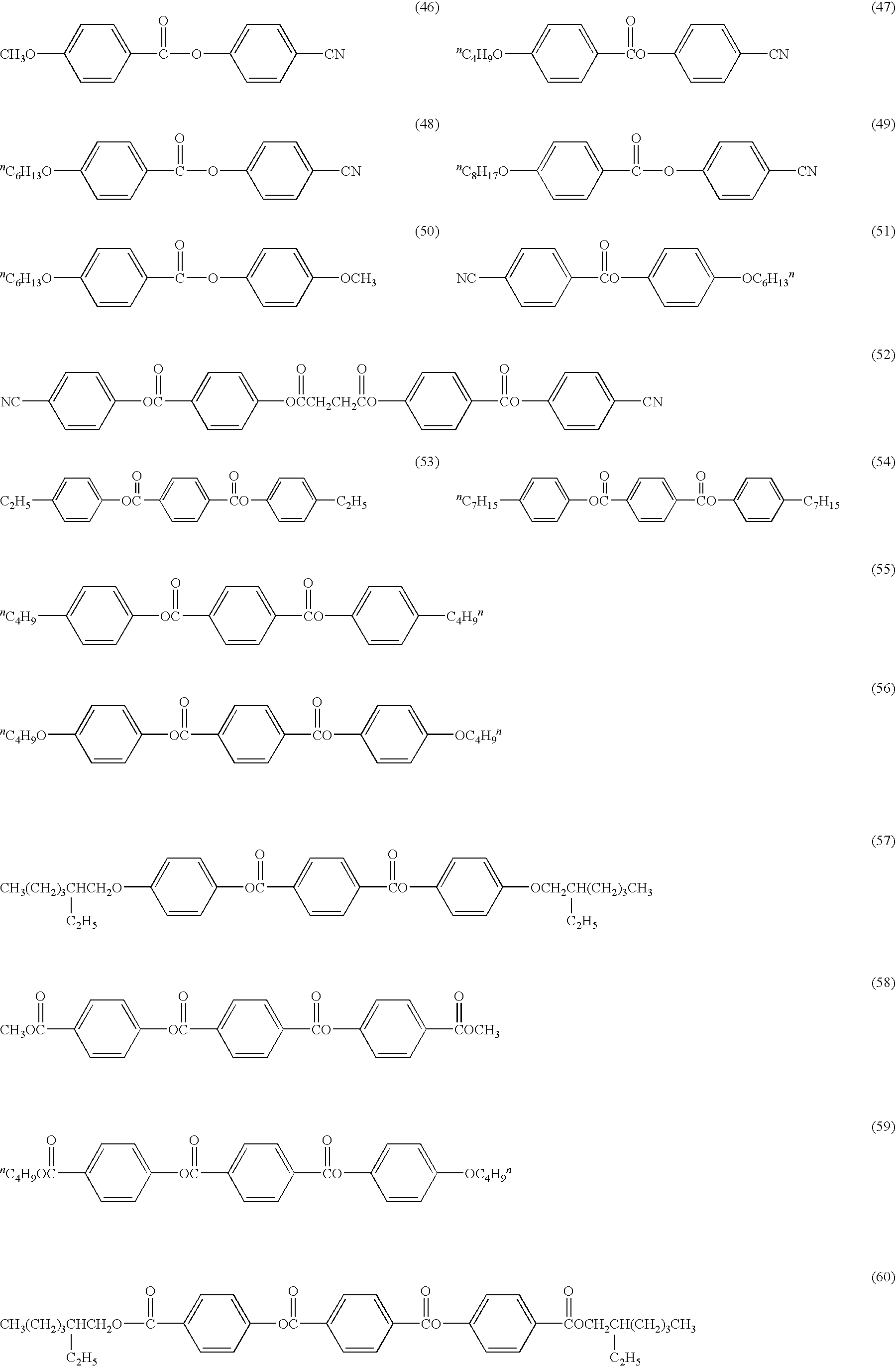

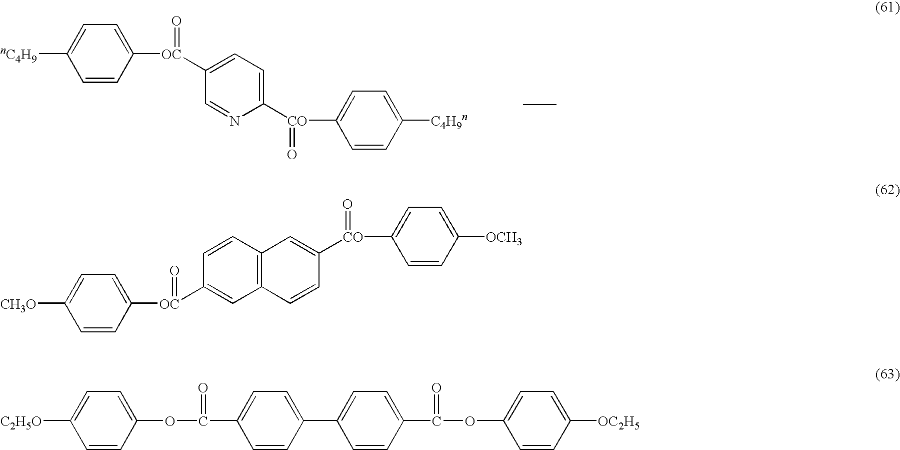

Two kinds or more of the rod-shaped compounds, which have a maximum absorption wavelength (λmax) of less than 250 nm in an ultraviolet spectrum of the solution, may be used simultaneously.

A rod-shaped compound can be synthesized according to methods described in references. As the references, Mol. Cryst. Liq. Cryst., vol. 53, p 229 (1979); Mol. Cryst. Liq. Cryst., vol. 89, p 93 (1982); Mol. Cryst. Liq. Cryst., vol. 145, p 111 (1987); Mol. Cryst. Liq. Cryst., vol. 170, p 43 (1989); Journal of the American Chemical Society, vol. 113, p 1349 (1991); Journal of the American Chemical Society, vol. 118, p 5346 (1996); Journal of the American Chemical Society, vol. 92, p 1582 (1970); Journal of Organic Chemistry, vol. 40, p 420 (1975); and Tetrahedron, vol. 48, No. 16, p 3437 (1992) can be mentioned.

### (3) Compound Having a Positive Birefringence

A compound having a positive birefringence means a polymer of such that, when light has come to a layer formed of the molecules thereof as aligned monoaxially, then the refractive index of the light in the alignment direction is larger than the refractive index of the light in the direction perpendicular to the alignment direction.

As the compound having a positive birefringence, is not limited, includes a polymer having a positive intrinsic birefringence such as polyamide, polyimide, polyester, polyetherketone, polyamideimide and polyesterimide, preferably polyetherketone and polyester-type polymers, more preferably polyester-type polymers.

The polyester-type polymers is one produced by reaction of a mixture of an aliphatic dicarboxylic acid having from 2 to 20 carbon atoms and an aromatic dicarboxylic acid having from 8 to 20 carbon atoms, and a diol selected from the group consisting of aliphatic diols having from 2 to 12 carbon atoms, alkyl ether diols having from 4 to 20 carbon atoms and aromatic diols having from 6 to 20 carbon atoms. Both ends of the reaction product may be as such, or may be blocked by further reaction with monocarboxylic acids, monoalcohols or phenols. The terminal blocking may be effected for the reason that the absence of a free carboxylic acid in the plasticizer is effective for the storability of the plasticizer. The dicarboxylic acid for the polyester plasticizer for use in the invention is preferably an aliphatic dicarboxylic having from 4 to 20 carbon atoms, or an aromatic dicarboxylic acid having from 8 to 20 carbon atoms.

The aliphatic dicarboxylic acids having from 2 to 20 carbon atoms preferably include, for example, oxalic acid, malonic acid, succinic acid, maleic acid, fumaric acid, glutaric acid, adipic acid, pimelic acid, suberic acid, azelaic acid, sebacic acid, dodecanedicarboxylic acid and 1,4-cyclohexanedicarboxylic acid.

The aromatic dicarboxylic acids preferably for use in the film of the invention having from 8 to 20 carbon atoms include phthalic acid, terephthalic acid, isophthalic acid, 1,5-naphthalene dicarboxylic acid, 1,4-naphthalene dicarboxylic acid, 1,8-naphthalene dicarboxylic acid, 2,8-naphthalene dicarboxylic acid, 2,6-naphthalene dicarboxylic acid, etc.

More preferred aliphatic dicarboxylic acids in these are malonic acid, succinic acid, maleic acid, fumaric acid, glutaric acid, adipic acid, azelaic acid, 1,4-cyclohexanedicarboxylic acid. More preferred aromatic dicarboxylic acids in these are phthalic acid, terephthalic acid, isophthalic acid, 1,5-naphthalene dicarboxylic acid and 1,4-naphthalene dicarboxylic acid. Particularly preferred aliphatic dicarboxylic acids are succinic acid, glutaric acid and adipic acid and particularly preferable aromatic dicarboxylic acids are phthalic acid, terephthalic acid and isophthalic acid.

At least one kind of above-mentioned aliphatic dicarboxylic acid and at least one kind of the aromatic dicarboxylic acid are used in combination. The combination of these acids is not limited and several kinds of each ingredient may be used in combination.

The diol and the aromatic diol used for the compound having a positive birefringence are selected, for example, from aliphatic diols having from 2 to 20 carbon atoms, alkyl ether diols having from 4 to 20 carbon atoms, and aromatic diols having from 6 to 20 carbon atoms.

Examples of the aliphatic diol having from 2 to 20 carbon atoms include an alkyldiol and an alicyclic diol. For example, an ethandiol, 1,2-propandiol, 1,3-propandiol, 1,2-butandiol, 1,3-butandiol, 2-methyl-1,3-propandiol, 1,4-butandiol, 1,5-pentandiol, 2,2-dimethyl-1,3-propandiol (neopentyl glycol), 2,2-diethyl-1,3-propandiol (3,3-dimethylolpentane), 2-n-buthyl-2-ethyl-1,3-propandiol (3,3-dimethylolheptane), 3-methyl-1,5-pentandiol, 1,6-hexandiol, 2,2,4-trimethyl-1,3-pentandiol, 2-ethyl-1,3-hexandiol, 2-methyl-1,8-octandiol, 1,9-nonandiol, 1,10-decandiol, 1,12-octadecandiol, etc. One or more of these glycols may be used either singly or as combined mixture.

Specific examples of preferred aliphatic diols include an ethandiol, 1,2-propandiol, 1,3-propandiol, 1,2-butandiol, 1,3-butandiol, 2-methyl-1,3-propandiol, 1,4-butandiol, 1,5-pentandiol, 3-methyl-1,5-pentandiol, 1,6-hexandiol, 1,4-cyclohexandiol, 1,4-cyclohexandimethanol. Particularly preferred examples include ethandiol, 1,2-propandiol, 1,3-propandiol, 1,2-butandiol, 1,3-butandiol, 1,4-butandiol, 1,5-pentandiol, 1,6-hexandiol, 1,4-cyclohexandiol, 1,4-cyclohexanedimethanol.

Specific examples of preferred alkyl ether diols having from 4 to 20 carbon atoms are polytetramethylene ether glycol, polyethylene ether glycol, polypropylene ether glycol, and combinations of these. The average degree of polymerization is not limited in particular, and it is preferably from 2 to 20, more preferably 2 to 10, further preferably from 2 to 5, especially preferably from 2 to 4. As these examples, Carbowax resin, Pluronics resin and Niax resin are commercially available as typically useful polyether glycols.

Specific examples of aromatic diols having from 6 to 20 carbon atoms, not limited, include Bisphenol A, 1,2-hydroxybenzene, 1,3-hydroxybenzene, 1,4-hydroxybenzene, 1,4-dimethylolbenzene, and preferably include bisphenol A, 1,4-hydroxybenzene and 1,4-dimethylolbenzene.

In the invention, especially preferred is a compound having a positive birefringence of which the terminal is blocked with an alkyl group or an aromatic group. The terminal protection with a hydrophobic functional group is effective against aging at high temperature and high humidity, by which the hydrolysis of the ester group is retarded.

Preferably, the compound having a positive birefringence is protected with a monoalcohol residue or a monocarboxylic acid residue in order that both ends of the compound having a positive birefringence are not a carboxylic acid or a hydroxyl group. In this case, the monoalcohol residue is preferably a substituted or unsubstituted monoalcohol residue having from 1 to 30 carbon atoms, including, for example, aliphatic alcohols such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodecaoctanol, allyl alcohol, oleyl alcohol; and substituted alcohols such as benzyl alcohol, 3-phenylpropanol.

Alcohol residues for terminal blocking that are preferred for use in the invention are methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol, benzyl alcohol, more preferably methanol, ethanol, propanol, isobutanol, cyclohexyl alcohol, 2-ethylhexyl alcohol, isononyl alcohol and benzyl alcohol.

In blocking with a monocarboxylic acid residue, the monocarboxylic acid for use as the monocarboxylic acid residue is preferably a substituted or unsubstituted monocarboxylic acid having from 1 to 30 carbon atoms. It may be an aliphatic monocarboxylic acid or an aromatic monocarboxylic acid. Preferred aliphatic monocarboxylic acids are described. They include acetic acid, propionic acid, butanoic acid, caprylic acid, caproic acid, decanoic acid, dodecanoic acid, stearic acid, oleic acid. Preferred aromatic monocarboxylic acids are, for example, benzoic acid, p-tert-butylbenzoic acid, p-tert-amylbenzoic acid, orthotoluic acid, metatoluic acid, paratoluic acid, dimethylbenzoic acid, ethylbenzoic acid, normal-propylbenzoic acid, aminobenzoic acid, acetoxybenzoic acid. One or more of these may be used either singly or as combined.

The compound having a positive birefringence may be easily produced according to any of a thermal melt condensation method of polyesterification or interesterification of the above-mentioned dicarboxylic acid and diol and/or monocarboxylic acid or monoalcohol for terminal blocking, or according to an interfacial condensation method of an acid chloride of those acids and a glycol in an ordinary manner. The compounds having a positive birefringence are described in detail in Koichi Murai's “Additives, Their Theory and Application” (by Miyuki Publishing, first original edition published on Mar. 1, 1973). The materials described in JP-A 05-155809, 05-155810, 05-197073, 2006-259494, 07-330670, 2006-342227, 2007-003679 are also usable herein.

Specific examples of the compounds having a positive birefringence are shown below, to which, however, the compound having a positive birefringence for the invention should not be limited.

TABLE 1

| | Dicarboxylic acid | | | | | Number |
|---|---|---|---|---|---|---|
| | Aromatic | Aliphatic | Dicarboxylic | Diol | | average |
| | dicarboxylic | dicarboxylic | acid ratio | Aliphatic | | molecular |
| | acid | acid | (Mol %) | diol | Ends of polymer | weight |
| P-1 | — | AA | 100 | Ethandiol | Hydroxyl group | 1000 |
| P-2 | — | AA | 100 | Ethandiol | Hydroxyl group | 2000 |
| P-3 | — | AA | 100 | Propandiol | Hydroxyl group | 2000 |
| P-4 | — | AA | 100 | Butandiol | Hydroxyl group | 2000 |
| P-5 | — | AA | 100 | Hexandiol | Hydroxyl group | 2000 |
| P-6 | — | AA/SA | 60/40 | Ethandiol | Hydroxyl group | 900 |
| P-7 | — | AA/SA | 60/40 | Ethandiol | Hydroxyl group | 1500 |
| P-8 | — | AA/SA | 60/40 | Ethandiol | Hydroxyl group | 1800 |
| P-9 | — | SA | 100 | Ethandiol | Hydroxyl group | 1500 |
| P-10 | — | SA | 100 | Ethandiol | Hydroxyl group | 2300 |
| P-11 | — | SA | 100 | Ethandiol | Hydroxyl group | 6000 |
| P-12 | — | SA | 100 | Ethandiol | Hydroxyl group | 1000 |
| P-13 | PA | SA | 50/50 | Ethandiol | Hydroxyl group | 1000 |
| P-14 | PA | SA | 50/50 | Ethandiol | Hydroxyl group | 1800 |
| P-15 | PA | AA | 50/50 | Ethandiol | Hydroxyl group | 2300 |
| P-16 | PA | SA/AA | 40/30/30 | Ethandiol | Hydroxyl group | 1000 |
| P-17 | PA | SA/AA | 50/20/30 | Ethandiol | Hydroxyl group | 1500 |
| P-18 | PA | SA/AA | 50/30/20 | Ethandiol | Hydroxyl group | 2600 |
| P-19 | TPA | SA | 50/50 | Ethandiol | Hydroxyl group | 1000 |
| P-20 | TPA | SA | 50/50 | Ethandiol | Hydroxyl group | 1200 |
| P-21 | TPA | AA | 50/50 | Ethandiol | Hydroxyl group | 2100 |
| P-22 | TPA | SA/AA | 40/30/30 | Ethandiol | Hydroxyl group | 1000 |
| P-23 | TPA | SA/AA | 50/20/30 | Ethandiol | Hydroxyl group | 1500 |
| P-24 | TPA | SA/AA | 50/30/20 | Ethandiol | Hydroxyl group | 2100 |
| P-25 | PA/TPA | AA | 15/35/50 | Ethandiol | Hydroxyl group | 1000 |
| P-26 | PA/TPA | AA | 20/30/50 | Ethandiol | Hydroxyl group | 1000 |
| P-27 | PA/TPA | SA/AA | 15/35/20/30 | Ethandiol | Hydroxyl group | 1000 |
| P-28 | PA/TPA | SA/AA | 20/30/20/30 | Ethandiol | Hydroxyl group | 1000 |
| P-29 | PA/TPA | SA/AA | 10/50/30/10 | Ethandiol | Hydroxyl group | 1000 |
| P-30 | PA/TPA | SA/AA | 5/45/30/20 | Ethandiol | Hydroxyl group | 1000 |

TABLE 2

| | Dicarboxylic acid | | | | | Number |
|---|---|---|---|---|---|---|
| | Aromatic | Aliphatic | Dicarboxylic | | | average |
| | dicarboxylic | dcarboxylic | acid ratio | Diol | | molecular |
| | acid | acid | (Mol %) | Aliphatic diol | Ends of polymer | weight |
| P-31 | — | AA | 100 | Ethandiol | Acetyl ester residue | 1000 |
| P-32 | — | AA | 100 | Ethandiol | Acetyl ester residue | 2000 |
| P-33 | — | AA | 100 | Propandiol | Acetyl ester residue | 2000 |
| P-34 | — | AA | 100 | Butandiol | Acetyl ester residue | 2000 |
| P-35 | — | AA | 100 | Hexandiol | Acetyl ester residue | 2000 |
| P-36 | — | AA/SA | 60/40 | Ethandiol | Acetyl ester residue | 900 |
| P-37 | — | AA/SA | 60/40 | Ethandiol | Acetyl ester residue | 1000 |
| P-38 | — | AA/SA | 60/40 | Ethandiol | Acetyl ester residue | 2000 |
| P-39 | — | SA | 100 | Ethandiol | Acetyl ester residue | 1000 |
| P-40 | — | SA | 100 | Ethandiol | Acetyl ester residue | 3000 |
| P-41 | — | SA | 100 | Ethandiol | Acetyl ester residue | 5500 |
| P-42 | — | SA | 100 | Ethandiol | Acetyl ester residue | 1000 |
| P-43 | PA | SA | 50/50 | Ethandiol | Acetyl ester residue | 1000 |
| P-44 | PA | SA | 50/50 | Ethandiol | Acetyl ester residue | 1500 |
| P-45 | PA | AA | 50/50 | Ethandiol | Acetyl ester residue | 2000 |
| P-46 | PA | SA/AA | 40/30/30 | Ethandiol | Acetyl ester residue | 1000 |
| P-47 | PA | SA/AA | 50/20/30 | Ethandiol | Acetyl ester residue | 1500 |
| P-48 | PA | SA/AA | 50/30/20 | Ethandiol | Acetyl ester residue | 2000 |
| P-49 | TPA | SA | 50/50 | Ethandiol | Acetyl ester residue | 1000 |
| P-50 | TPA | SA | 50/50 | Ethandiol | Acetyl ester residue | 1500 |
| P-51 | TPA | AA | 50/50 | Ethandiol | Acetyl ester residue | 2200 |
| P-52 | TPA | SA/AA | 40/30/30 | Ethandiol | Acetyl ester residue | 1000 |
| P-53 | TPA | SA/AA | 50/20/30 | Ethandiol | Acetyl ester residue | 1500 |
| P-54 | TPA | SA/AA | 50/30/20 | Ethandiol | Acetyl ester residue | 2000 |
| P-55 | PA/TPA | AA | 15/35/50 | Ethandiol | Acetyl ester residue | 1000 |
| P-56 | PA/TPA | AA | 25/25/50 | Ethandiol | Acetyl ester residue | 1000 |
| P-57 | PA/TPA | SA/AA | 15/35/20/30 | Ethandiol | Acetyl ester residue | 1000 |
| P-58 | PA/TPA | SA/AA | 20/30/20/30 | Ethandiol | Acetyl ester residue | 1000 |
| P-59 | PA/TPA | SA/AA | 10/50/30/10 | Ethandiol | Acetyl ester residue | 1000 |
| P-60 | PA/TPA | SA/AA | 5/45/30/20 | Ethandiol | Acetyl ester residue | 1000 |
| P-61 | IPA | AA/SA | 20/40/40 | Ethandiol | Acetyl ester residue | 1000 |
| P-62 | 2,6-NPA | AA/SA | 20/40/40 | Ethandiol | Acetyl ester residue | 1200 |
| P-63 | 1,5-NPA | AA/SA | 20/40/40 | Ethandiol | Acetyl ester residue | 1200 |
| P-64 | 1,4-NPA | AA/SA | 20/40/40 | Ethandiol | Acetyl ester residue | 1200 |
| P-65 | 1,8-NPA | AA/SA | 20/40/40 | Ethandiol | Acetyl ester residue | 1200 |
| P-66 | 2,8-NPA | AA/SA | 20/40/40 | Ethandiol | Acetyl ester residue | 1200 |

In Table 1 and Table 2, PA is phthalic acid, TPA is terephthalic acid, IPA is isophthalic acid, AA is adipic acid, SA is succinic acid, 2,6-NPA is 2,6-naphthalenedicarboxylic acid, 2,8-NPA is 2,8-naphthalenedicarboxylic acid, 1,5-NPA is 1,5-naphthalenedicarboxylic acid, 1,4-NPA is 1,4-naphthalenedicarboxylic acid, 1,8-NPA is 1,8-naphthalenedicarboxylic acid. Diols in Table 1 and Table 2 is only used as a diol.

The compound having a positive birefringence is added in an amount of preferably from 1 to 30 parts by mass relative to 100 parts by mass of the cellulose resin, more preferably from 4 to 25 parts by mass relative to 100 parts by mass of the cellulose resin, still more preferably from 10 to 20 parts by mass relative to 100 parts by mass of the cellulose resin.

### (Other Additives)

The cellulose acylate film of the invention may contain any other additives, in addition to the above-mentioned compound having a negative birefringence and retardation enhancer. These other additives include antiaging agent, UV absorbent, release promoter, plasticizer, etc.

### (Antioxidant)

Any known antioxidant may be added to the cellulose acylate solution in the invention. For example, phenolic or hydroquinone-based antioxidants may be added, including 2,6-di-tert-butyl-4-methylphenol, 4,4′-thiobis-(6-tert-butyl-3-methylphenol), 1,1′-bis(4-hydroxyphenyl)cyclohexane, 2,2′-methylenebis(4-ethyl-6-tert-butylphenol), 2,5-di-tert-butylhydroquinone, pentaerythrityl tetrakis[3-(3,5-di-tert-butyl-4-hydroxyphenyl)propionate], etc. Also preferred are phosphorus-containing antioxidants such as tris(4-methoxy-3,5-diphenyl) phosphite, tris(nonylphenyl) phosphite, tris(2,4-di-tert-butylphenyl) phosphite, bis(2,6-di-tert-butyl-4-methylphenyl)pentaerythritol diphosphite, bis(2,4-di-tert-butylphenyl)pentaerythritol diphosphite, etc. The amount of the antioxidant to be added may be from 0.05 to 5.0 parts by mass relative to 100 parts by mass of the cellulose resin.

### (UV Absorbent)

From the viewpoint of preventing the deterioration of polarizers and liquid crystals, a UV absorbent is favorably added to the cellulose acylate solution in the invention. Preferably, the UV absorbent has an excellent UV-absorbing capability at a wavelength of at most 370 nm, and has little absorption of visible light having a wavelength of at least 400 nm, from the viewpoint of good liquid crystal display capability. Preferred examples of the UV absorbent for use in the invention include hindered phenol compounds, hydroxybenzophenone compounds, benzotriazole compounds, salicylate compounds, benzophenone compounds, cyanoacrylate compounds, nickel complex compounds, etc. Examples of the hindered phenol compounds include 2,6-di-tert-butyl-p-cresol, pentaerythrityl tetrakis[3-(3,5-di-tert-butyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, tris-(3,5-di-tert-butyl-4-hydroxybenzyl) isocyanurate, etc. Examples of the benzotriazole compounds include 2-(2′-hydroxy-5′-methylphenyl)benzotriazole, 2,2-methylenebis(4-(1,1,3,3-tetramethylbutyl)-6-(2H-benzotriazol-2-yl)phenol), (2,4-bis(n-octylthio)-6-(4-hydroxy-3,5-di-tert-butylanilino)-1,3,5-triazine, triethylene glycol-bis[3-(3-tert-butyl-5-methyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, 2-(2′-hydroxy-3′,5′-di-tert-butylphenyl)-5-chlorobenzotriazole, 2-(2′-hydroxy-3′,5′-di-tert-amylphenyl)-5-chlorobenzotriazole, 2,6-di-tert-butyl-p-cresol, pentaerythrityl tetrakis[3-(3,5-di-tert-butyl-4-hydroxyphenyl)propionate], etc. The amount of the UV absorbent to be added is preferably from 1 ppm to 1.0%, more preferably from 10 to 1000 ppm in terms of the ratio by mass thereof in the entire cellulose ester film.

### (Release Promoter)

The film of the invention may contain a release promoter. The release promoter may be, for example, in an amount of from 0.001 to 1% by mass. Any known release promoter may be used herein, and for example, ethyl citrate and the like are mentioned as its examples.

### (Plasticizer)

For improving the mechanical properties of the film of the invention or for increasing the drying speed thereof, a plasticizer may be added to the film. As the plasticizer, usable are phosphates or carboxylates. Examples of the phosphates include triphenyl phosphate (TPP) and tricresyl phosphate (TCP). The carboxylates are typically phthalates and citrates. Examples of the phthalates include dimethyl phthalate (DMP), diethyl phthalate (DEP), dibutyl phthalate (DBP), dioctyl phthalate (DOP), diphenyl phthalate (DPP) and diethylhexyl phthalate (DEHP). Examples of the citrates include triethyl O-acetylcitrate (OACTE) and tributyl O-acetylcitrate (OACTB). Examples of other carboxylates include butyl oleate, methylacetyl ricinoleate, dibutyl sebacate, and various trimellitates. Preferred for use herein are phthalate plasticizers (DMP, DEP, DBP, DOP, DPP, DEHP). More preferred are DEP and DPP. The amount of the plasticizer to be added is preferably from 0.1 to 25% by mass of the cellulose resin, more preferably from 1 to 20% by mass of the cellulose resin, most preferably from 3 to 15% by mass of the cellulose resin.

### [Cellulose Ester Film]

The cellulose acylate film of the invention is characterized by comprising a cellulose acylate resin has at least one compound having a negative birefringence and satisfying the following inequalities (a) and (b):

30 nm<Re<100 nm (a)

80 nm<Rth<300 nm (b)

wherein Re indicates retardation in the plane of the cellulose acylate film, and Rth indicates retardation in the thickness direction of the cellulose acylate film.

The cellulose acylate film may be a single-layered film or a multilayered film. For example, in case where the cellulose acylate film of the invention is produced through co-casting, it may have at least two layers of a core layer and a skin layer. In this case, the polymer X may be in any of the core layer or the skin layer, but is preferably in the core layer.

### (Haze)

The cellulose acylate film of the invention preferably has a haze of less than 1%, more preferably less than 0.5%. Having a haze of less than 1%, the transparency of the cellulose acylate film is enough high to use as a cellulose acylate film.

### (Mean Water Content)

The cellulose acylate film of the invention preferably has an equilibrium water content of at most 10% at 25° C. and relative humidity 60%, more preferably at most 5%, even more preferably at most 3%. Having a mean water content of at most 10%, the film may well answer to the ambient humidity change and is therefore favorable since the optical properties and the dimension thereof change little.

### (Retardation (Re and Rth))

The preferred range of the retardation of the cellulose acylate film changes depending on the use thereof. Re and Rth of the cellulose acylate film of the invention are 30 nm<Re<100 nm and 80 nm<Rth<300 nm. Preferably, Re and Rth of the film are 30 nm<Re<80 nm and 80 nm<Rth<200 nm, more preferably 30 nm<Re<70 nm and 80 nm<Rth<150 nm.

Re(λ) and Rth(λ) represent, herein, the retardation in the plane and the retardation in the thickness direction, respectively, at a wavelength of λ. Re(λ) is measured with KOBRA 21ADH or WR (by Oji Scientific Instruments) while allowing light having the wavelength of λ nm to enter in the normal direction of a film.

With the in-plane slow axis (determined by KOBRA 21ADH or WR) taken as the inclination axis (rotation axis) of the sample (in case where the sample has no slow axis, the rotation axis of the sample may be in any in-plane direction of the sample), Re(λ) of the sample is measured at 6 points in all thereof, up to +50° relative to the normal line direction of the sample at intervals of 10°, by applying a light having a wavelength of λ nm from the inclined direction of the sample.

With the slow axis taken as the inclination axis (rotation axis) (in case where the sample has no slow axis, the rotation axis of the sample may be in any in-plane direction of the film), the retardation values of the sample are measured in any inclined two directions; and based on the data and the mean refractive index and the inputted thickness of the sample, Rth may be calculated according to the following formulae (11) and (12).

The mean refractive index may be used values described in catalogs for various types of optical films. When the mean refractive index has not known, it may be measured with Abbe refractometer. The mean refractive index for major optical film is described below: cellulose acylate (1.48), cycloolefin polymer (1.52), polycarbonate (1.59), polymethylmethacrylate (1.49) and polystyrene (1.59).

By inputting the value of these average refraction indices and thickness, KOBRA 21ADH or WR computes nx, ny, nz. From the computed nx, ny, nz, Nz=(nx−nz)/(nx−ny) is computed further.

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos \{ {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad ( 11 )$$

The above Re (θ) represents the retardation in a direction that inclines in the degree of θ from the normal direction; and d is a thickness of the film.

Rth={(nx+ny)/2−nz}×d (12)

In this, the mean refractive index n is needed as a parameter, and it is measured with an Abbe refractiometer (Atago's Abbe Refractiometer 2-T).

### (Wet Heat Durability)

When stored for a long period of time under high-temperature high-humidity condition, the optical properties of the cellulose acylate film of the invention change little. To that effect, the wet heat durability of the optical properties of the film of the invention is improved, and therefore the film can exhibit a high retardation for a long period of time under high-temperature high-humidity condition. Accordingly, the cellulose acylate film of the invention is favorable for use in high-temperature high-humidity condition.

Preferably, the retardation in the plane of the cellulose acylate film of the invention, Re, changes by from −10% to 10% after the cellulose acylate film is kept at 60° C. and relative humidity 90% for 150 hours (hereinafter this difference per original Re of the cellulose acylate film of the invention just after its production may be referred to as “ΔRe”), more preferably changes by from −8% to 8%, even more preferably changes by from −5% to 5%.

Preferably, the retardation in the thickness direction of the cellulose acylate film, Rth, changes by from −10% to 10% after the cellulose acylate film is kept at 60° C. and relative humidity 90% for 150 hours (hereinafter this difference per original Rth of the cellulose acylate film of the invention just after its production may be referred to as “ΔRth”), more preferably changes by from −8% to 8%, even more preferably changes by from −5% to 5%.

### (Film Thickness)

Preferably, the thickness of the cellulose acylate film of the invention is from 20 to 80 μm, more preferably from 30 to 60 μm. Having a thickness of at least 20 μm, the film is favorable since the handlability thereof in producing a web-like film is good. Having a thickness of at most 80 μm, the film is also favorable since it readily answers to the ambient moisture change and may readily maintain its optical properties.

### [Production of Cellulose Acylate Film]

For producing the film of the invention, widely employable is any known method for producing an ordinary cellulose ester film. Preferably, the film is produced according to a solvent casting method. In the solvent casting method, the film is produced with a solution in which a cellulose acylate is dissolved (hereinafter this may be referred to as “dope”).

Organic solvents are preferably selected from ethers having 3-12 carbon atoms, esters having 3-12 carbon atoms, ketones having 3-12 carbon atoms and halogenated hydrocarbons having 1-6 carbon atoms. The ethers, the ketones and the esters may have a cyclic structure. Compounds having two or more functional groups of ethers, esters and ketones (i.e., —O—, —CO— and —COO—) are also usable herein as the organic solvent; and they may have any other functional group such as an alcoholic hydroxyl group. In case where the organic solvent has two or more functional groups, the number of the carbon atoms constituting the organic solvent may fall within a range of the number of carbon atoms that constitute the compound having any of those functional groups.

Examples of the ethers having 3-12 carbon atoms are diisopropyl ether, dimethoxymethane, dimethoxyethane, 1,4-dioxane, 1,3-dioxolane, tetrahydrofuran, anisole and phenetole.

Examples of the ketones having 3-12 carbon atoms are acetone, methyl ethyl ketone, diethyl ketone, diisobutyl ketone, cyclohexanone and methylcyclohexanone.

Examples of the esters having 3-12 carbon atoms are ethyl formate, propyl formate, pentyl formate, methyl acetate, ethyl acetate and pentyl acetate.

Examples of the organic solvents having plural functional groups are 2-ethoxyethyl acetate, 2-methoxyethanol and 2-butoxyethanol.

The number of the carbon atoms constituting the halogenohydrocarbon is preferably 1 or 2, most preferably 1. The halogen in the halogenohydrocarbon is preferably chlorine. The proportion of the hydrogen atoms in the halogenohydrocarbon substituted with a halogen is preferably from 25 to 75 mol %, more preferably from 30 to 70 mol %, even more preferably from 35 to 65 mol %, most preferably from 40 to 60 mol %. Methylene chloride is a typical halogenohydrocarbon.

Two or more different types of organic solvents may be mixed for use in the invention.

The cellulose acylate solution may be prepared according to an ordinary method. In one general method, the solution is processed at a temperature not lower than 0° C. (room temperature or high temperature). For preparing the solution, employable is a method and an apparatus for dope preparation according to an ordinary solvent casting method. In the ordinary method, preferably used is a halogenohydrocarbon (especially methylene chloride) as the organic solvent.

The amount of the cellulose acylate is so controlled that it may be in the solution in an amount of from 10 to 40% by mass. The amount of the cellulose acylate is preferably from 10 to 30% by mass. To the organic solvent (main solvent), the compound having a negative birefringence and any additives mentioned above can be added.

The solution is prepared by stirring a cellulose acylate and an organic solvent at room temperature (0 to 40° C.). A high-concentration solution may be stirred under pressure and under heat. Concretely, a cellulose acylate and an organic solvent are put into a pressure chamber, then closed and stirred therein and under heat at a temperature within a range between the boiling point of the solvent at room temperature and the boiling point under the pressure. The heating temperature is generally 40° C. or higher, preferably from 60 to 200° C., more preferably from 80 to 110° C.

The ingredients may be put into the chamber after roughly premixed. They may be put into the chamber one after another. The chamber must be so planned that the contents therein could be stirred. An inert gas such as nitrogen gas or the like may be introduced into the chamber to pressurize it. The solvent may be heated, and vapor pressure of it may be utilized to pressurize the chamber. Alternatively, after the chamber is closed, the ingredients may be introduced thereinto under pressure.

Preferably, the contents in the chamber are heated in an external heating mode. For example, a jacket type heating unit may be used. A plate heater may be disposed outside the chamber, and a liquid may be circulated through the pipeline disposed in the heater to thereby heat the entire chamber.

Also preferably, a stirring blade may be disposed inside the chamber, with which the contents may be stirred. The stirring blade preferably has a length that reaches near the wall of the chamber. At the tip of the stirring blade, a scraper is preferably provided for renewing the liquid film formed on the wall of the chamber.

The chamber may be equipped with various meters such as a pressure gauge, a thermometer, etc. In the chamber, the ingredients are dissolved in the solvent. Thus prepared, the dope is taken out of the chamber after cooled, or after taken out of it, the dope may be cooled with a heat exchanger or the like.

The solution may also be prepared according to a cooling dissolution method. According to the cooling dissolution method, a cellulose acylate may be dissolved even in an organic solvent in which it can be hardly dissolved in an ordinary dissolution method. For the solvent in which a cellulose acylate can be dissolved in an ordinary dissolution method, the cooling dissolution method is advantageous in that a uniform solution can be prepared rapidly.

In the cooling dissolution method, first, a cellulose acylate is gradually added to an organic solvent at room temperature with stirring. The amount of the cellulose acylate is so controlled that the resulting mixture can contain it in an amount of from 10 to 40% by mass. The amount of the cellulose ester is more preferably from 10 to 30% by mass. Further, any desired additives to be mentioned below may be added to the mixture.

Next, the mixture is cooled to −100 to −10° C. (preferably −80 to −10° C., more preferably −50 to −20° C., most preferably −50 to −30° C.). The cooling may be attained, for example, in a dry ice/methanol bath (−75° C.) or in a cooled diethylene glycol solution (−30 to −20° C.). Thus cooled, the mixture of cellulose acylate and organic solvent is solidified.

The cooling speed is preferably at least 4° C./min, more preferably at least 8° C./min, most preferably at least 12° C./min. The cooling speed is preferably higher, but its theoretical uppermost limit is 10000° C./sec, the technical uppermost limit is 1000° C./sec, and the practicable uppermost limit is 100° C./sec. The cooling speed is a value computed by dividing the difference between the temperature at the start of the cooling and the final cooling temperature by the time taken from the start of the cooling to the arrival to the final cooling temperature.

Further, this is heated at 0 to 200° C. (preferably 0 to 150° C., more preferably 0 to 120° C., most preferably 0 to 50° C.), and the cellulose acylate is thereby dissolved in the organic solvent. For the heating, the solid may be left at room temperature, or may be heated in a hot bath. The heating speed is preferably at least 4° C./min, more preferably at least 8° C./min, most preferably at least 12° C./min. The heating speed is preferably higher; but its theoretical uppermost limit is 10000° C./sec, the technical uppermost limit is 1000° C./sec, and the practicable uppermost limit is 100° C./sec. The heating speed is a value computed by dividing the difference between the temperature at the start of the heating and the final heating temperature by the time taken from the start of the heating to the arrival to the final heating temperature.

As in the above, a uniform solution can be obtained. When the dissolution is insufficient, then the cooling and heating operation may be repeated. As to whether or not the dissolution is satisfactory may be determined merely by visually observing the outward appearance of the solution.

In the cooling dissolution method, preferably used is a closed container for the purpose of preventing the mixture from being contaminated with water from the dew formed in cooling. In the cooling and heating operation, preferably, the chamber is made under pressure in cooling and is made under reduced pressure in heating, to thereby shorten the dissolution time. For pressurizing and depressurizing the chamber, preferably used is a pressure chamber.

A 20% by mass solution prepared by dissolving a cellulose acylate (having a degree of total acetyl substitution of 60.9%, and having a viscosity-average degree of polymerization of 299) in methyl acetate according to the cooling dissolution method has a pseudo-phase transition point between a sol state and a gel state at around 33° C., when analyzed through differential scanning calorimetry (DSC), and at a temperature lower than the point, the solution is in the form of a uniform gel. Accordingly, the solution must be stored at a temperature not lower than the pseudo-phase transition temperature, preferably at around a temperature of the gel-phase transition temperature plus 10° C. or so. However, the pseudo-phase transition temperature differs, depending on the degree of total acetyl substitution and the viscosity-average degree of polymerization of the cellulose acylate and on the solution concentration and the organic solvent used.

From the thus-prepared cellulose acylate solution (dope), a cellulose acylate film can be produced according to a solvent casting method.

The dope is cast on a drum or a band, on which the solvent is evaporated away to form a film. Before cast, the concentration of the dope is preferably so planned that the solid content thereof is from 18 to 35% by mass. Preferably, the surface of the drum or the band is finished to be a mirror face. The casting and drying method in solvent casting is described in U.S. Pat. Nos. 2,336,310, 2,367,603, 2,492,078, 2,492,977, 2,492,978, 2,607,704, 2,739,069, 2,739,070, British Patents 640731, 736892, JP-B 45-4554, 49-5614, JP-A 60-176834, 60-203430, 62-115035.

Preferably, the dope is cast on a drum or a band at a surface temperature of not higher than 10° C. After thus cast, preferably, the dope is dried by exposing to the wind for at least 2 seconds. The formed film is peeled away from the drum or the band, and then it may be dried with the high-temperature wind of which the temperature is stepwise changed from 100° C. to 160° C. to thereby remove the residual solvent by vaporization. This method is described in JP-B 5-17844. According to the method, the time to be taken from the casting to the peeling may be shortened. In carrying out the method, the dope must be gelled at the surface temperature of the drum or the band on which it is cast.

### (Co-Casting)

In the invention, the prepared cellulose acylate solution may be cast onto a smooth band or drum serving as a metal support, as a single-layer solution; or plural cellulose acylate solutions for 2 or more layers may be co-cast thereon. In case where plural cellulose acylate solutions are co-cast, the cellulose acylate-containing solution may be cast onto a metal support through plural casting mouths disposed around the support at intervals in the machine direction, and the co-cast solutions may be laminated on the support to give a film. For example, the methods described in JP-A 61-158414, 1-122419, 11-198285 are employable. The cellulose acylate solution may be cast through two casting mouths to form a film, for which, for example, employable are the methods described in JP-B 60-27562, JP-A 61-94724, 61-947245, 61-104813, 61-158413, 6-134933. Also employable herein is a cellulose acylate film co-casting method of casting a flow of a high-viscosity cellulose acylate solution as enveloped with a low-viscosity cellulose acylate solution thereby simultaneously extruding both the high-viscosity and low-viscosity cellulose acylate solutions, as in JP-A 56-162617. Also preferred is an embodiment where the outer solution contains a larger amount of a poor solvent, alcohol than in the inner solution, as in JP-A 61-94724, 61-94725.

Two casting mouths may be used as follows: A film is formed on a metal support through the first casting mouth, then this is peeled, and on the other surface of the film opposite to that having kept in contact with the metal support, another film is formed through the second casting mouth. For example, the method is described in JP-B 44-20235. The cellulose acylate solutions to be cast may be the same or different with no specific limitation. In order to make the plural cellulose acylate layers have various functions, cellulose acylate solutions corresponding to the desired functions may be cast through the respective casting mouths. The cellulose acylate solution of the invention may be cast along with any other functional layers (e.g., adhesive layer, dye layer, antistatic layer, antihalation layer, UV absorbent layer, polarizing layer).

In case where a single-layer film is formed according to a conventional technique, a high-concentration and high-viscosity cellulose acylate solution must be extruded out in order to make the formed film have a desired thickness; but in such a case, the stability of the cellulose acylate solution is poor therefore causing various problems of solid deposition to be fish eyes or to roughen the surface of the film. For solving the problems, plural cellulose acylate solutions are cast out through different casting mouths, whereby high-density solutions can be extruded out at the same time on a metal support, and as a result, the surface properties of the formed films are bettered and films having excellent surface properties can be produced. In addition, since such thick cellulose acylate solutions can be used and the drying load in the process can be reduced, and the film producibility is enhanced.

In co-casting, the thickness of the outer layer and the inner layer is not specifically defined. Preferably, the thickness of the outer layer is from 1 to 50% of the overall thickness of the film, more preferably from 2 to 30%. In co-casting of three or more layers, the total thickness of the layer adjacent to the metal support and the outermost layer adjacent to air is defined to be the thickness of the outer layer.

In another embodiment of co-casting, cellulose acylate solutions in which the density of the additives such as the above-mentioned plasticizer, UV absorbent, mat agent and the like differs may be co-cast to produce a cellulose acylate film having a laminate structure. For example, a cellulose acylate film having a constitution of skin layer/core layer/skin layer can be produced. For example, the mat agent may be much in the skin layer, or may be only in the skin layer. The plasticizer and the UV absorbent may be more in the core layer than in the skin layer, or may be only in the core layer. The type of the plasticizer and the UV absorbent may differ between the core layer and the skin layer. For example, a low-volatile plasticizer and/or UV absorbent may be in the skin layer, and a plasticizer of excellent plasticization or a UV absorbent of excellent UV absorption may be added to the core layer. An embodiment of adding a release agent to only the skin layer on the side of the metal support is also preferred. In order to gel the solution by cooling the metal support in a cooling drum method, alcohol as a poor solvent may be more in the skin layer than in the core layer, and this is also a preferred embodiment. Tg may differ between the skin layer and the core layer. Preferably, Tg of the core layer is lower than that of the skin layer. The viscosity of the cellulose ester solution to be cast may differ between the skin layer and the core layer. Preferably, the viscosity of the solution for the skin layer is smaller than that for the core layer; however, the viscosity of the solution for the core layer may be smaller than that for the skin layer.

A method of drying the web that is dried on a drum or belt and is peeled away from it is described. The web peeled away at the peeling position just before one lap of the drum or the belt is conveyed according to a method where the web is led to pass alternately through rolls disposed like a houndstooth check, or according to a method where the peeled web is conveyed in a non-contact mode while both sides of the web are held by clips or the like. The drying may be attained according to a method where the wind at a predetermined temperature is given to both surfaces of the web (film) being conveyed, or according to a method of using a heating means such as microwaves, etc. Rapid drying may damage the surface smoothness of the formed film. Therefore, in the initial stage of drying, the web is dried at a temperature at which the solvent does not bubble, and after having gone on in some degree, the drying may be preferably attained at a high temperature. In the drying step after peeled away from the support, the film tends to shrink in the machine direction or in the cross direction owing to solvent evaporation. The shrinkage may be larger in drying at a higher temperature. Preferably, the shrinkage is inhibited as much as possible for bettering the surface condition of the film to be formed. From this viewpoint, for example, preferred is a method (tenter method) where the entire drying step or a part of the drying step is carried out with both sides of the web held with clips or pins so as to keep the width of the web, as in JP-A 62-46625. The drying temperature in the drying step is preferably from 100 to 145° C. The drying temperature, the drying wind speed and the drying time may vary depending on the solvent used, and are therefore suitably selected in accordance with the type and the combination of the solvent to be used. In producing the film of the invention, the web (film) peeled away from the support is stretched preferably when the residual solvent amount in the web is less than 120% by mass.

The residual solvent amount may be represented by the following formula:

Residual Solvent Amount (% by mass)={(M−N)/N}×100

wherein M means the mass of the web at an undefined point, and N means the mass of the web having the mass M, dried at 110° C. for 3 hours. When the residual solvent amount in the web is too much, then the web could not receive the effect of its stretching; but when too small, stretching the web is extremely difficult, and the web may be broken. More preferably, the residual solvent amount in the web is from 10 to 50% by mass, even more preferably from 12 to 35% by mass. In case where the draw ratio in stretching is too small, the film could not have a sufficient retardation; but when too large, the film would be difficult to be stretched and would be broken.

In the invention, the film produced according to a solution casting method and having a residual solvent amount falling within a specific range can be stretched, not heated at a high temperature; however, preferably, the film is stretched while dried, as the processing process may be shortened. However, when the temperature of the web is too high, then the plasticizer may evaporate away, and therefore, the temperature range is preferably from room temperature (15° C.) to 145° C. A method of stretching the film in two directions perpendicular to each other is effective for controlling the film refractivity, Nx, Ny and Nz to fall within the range of the invention. For example, when the film is stretched in the casting direction and when the shrinkage in the cross direction is too large, then the value Nz may increase too much. In this case, the problem may be solved by reducing the cross shrinkage of the film or by stretching the film in the cross direction. In case where the film is stretched in the cross direction, the film may have a refractivity distribution in the cross direction. This often occurs, for example, when a tenter method is employed for film stretching. This is a phenomenon to be caused by the generation of the shrinking force in the center part of the film while the edges of the film are kept fixed, and this may be considered as a so-called bowing phenomenon. Also in this case, the bowing phenomenon can be prevented by stretching the film in the casting direction, whereby the retardation distribution in the cross direction can be reduced. Further, by stretching the film in two directions perpendicular to each other, the film thickness fluctuation may be reduced. When the film thickness fluctuation of a cellulose acylate film is too large, then the distribution fluctuation thereof may also be large. The film thickness fluctuation of the cellulose acylate film is preferably within a range of ±3%, more preferably within a range of ±1%. For the above-mentioned objects, the method of stretching the film in two directions perpendicular to each other is effective, and the draw ratio in stretching in two directions perpendicular to each other is preferably from 1.2 to 2.0 times in one direction and from 0.7 to 1.0 time in the other direction. The mode of stretching the film by from 1.2 to 2.0 times in one direction and by from 0.7 to 1.0 time in the other direction means that the distance between the clips or the pins supporting the film is made to be from 0.7 to 1.0 times the distance therebetween before the stretching.

In general, in case where the film is stretched in the cross direction by 1.2 to 2.0 times, using a biaxial stretching tenter, a shrinking force acts on the perpendicular direction thereof, or that is, on the machine direction of the film.

Accordingly, when the film is stretched while a force is kept applied only in one direction, then the width of the film in the other direction perpendicular to that one direction may shrink. The method means that the shrinking degree is controlled without control of the width of the film, or that is, this means that the distance between the clips or the pins for width control is defined to be from 0.7 to 1.0 time the distance therebetween before stretching. In this case, a force of shrinking the film in the machine direction acts on the film owing to the stretching in the cross direction. The distance kept between the clips or the pins in the machine direction makes it possible to prevent any unnecessary tension from being given to the film in the machine direction thereof. The method of stretching the web is not specifically defined. For example, there are mentioned a method of providing plural rolls each running at a different peripheral speed and stretching the film in the machine direction based on the peripheral speed difference between the rolls, a method of holding both sides of the web with clips or pins and expanding the distance between the clips or pins in the machine direction to thereby stretch the film in the machine direction, or expanding the distance therebetween in the cross direction to thereby stretch the film in the cross direction, and a method of expanding the distance both in the machine direction and in the cross direction to thereby stretch film in both the machine and cross directions. Needless-to-say, these methods may be combined. In the so-called tenter method, preferably, the clip parts are driven according to a linear driving system, by which the film may be smoothly stretched with little risk of breaking, etc.

### [Polarizer]

The polarizer of the invention comprises the cellulose acylate film of the invention. Typically, the polarizer comprises the cellulose acylate film of the invention as a protective film for the polarizing element. A polarizer comprises a polarizing element and a transparent protective film disposed on at least one side of the element, in general two transparent protective films disposed on both sides of the element. In the invention, at least one protective film of the polarizer is formed of the cellulose acylate film of the invention. The other protective film may be the cellulose acylate film of the invention or may be any other ordinary cellulose acetate film or the like.

As mentioned above, a polarizer is constructed by laminating a polarizer-protective film on at least one surface of a polarizing element. The polarizing element may be any conventional one. For example, this is prepared by processing a hydrophilic polymer film such as a polyvinyl alcohol film with a dichroic dye such as iodine. Not specifically defined, the cellulose acylate film may be stuck to the polarizing element in any desired manner, for which, for example, an adhesive of an aqueous solution of a water-soluble polymer may be used. Preferably, the water-soluble polymer adhesive is an aqueous solution of completely-saponified polyvinyl alcohol.

The polarizer may have a retardation film provided on the protective film. Preferably, the retardation film is stuck with an adhesive. As the adhesive, for example, employable are those described in JP-A 2000-109771, 2003-34781.

Preferred embodiments of the constitution of the polarizer of the invention include a constitution of protective film/polarizing element/protective film/liquid crystal cell/cellulose acylate film of the invention/polarizing element/polarizer-protective film; or a constitution of polarizer-protective film/polarizing element/cellulose acylate film of the invention/liquid crystal cell/cellulose acylate film of the invention/polarizing element/polarizer-protective film. In particular, the polarizer of the invention is favorably stuck to a TN-mode, VA-mode or OCB-mode liquid crystal cell, thereby constructing liquid crystal displays excellent in viewing angle and visibility with little coloration. In particular, the polarizer comprising the cellulose acylate film of the invention is excellent in the humidity stability under humidity changing condition and in the long-term wet heat durability under high-temperature high-humidity condition, and therefore can maintain stable performance for a long period of time under high-temperature high-humidity condition. Excellently, in addition, the haze of the polarizer of the invention is low.

### [Liquid Crystal Display Device]

The cellulose acylate film and the polarizer having the film of the invention are usable in liquid crystal cells and liquid crystal display devices of various display modes. For these, proposed are various modes of TN (twisted nematic), IPS (in-plane switching), FLC (ferroelectric liquid crystal), AFLC (anti-ferroelectric liquid crystal), OCB (optically compensatory bend), STN (super twisted nematic), VA (vertically aligned) and HAN (hybrid aligned nematic) modes.

The OCB-mode liquid-crystal cell is a bend-alignment mode liquid crystal cell, in which the rod-shaped liquid-crystal molecules in the upper part of the liquid-crystal cell and those in the lower part thereof are aligned in the direction substantially oppositely (symmetrically) to each other. The OCB-mode liquid-crystal cell is disclosed in U.S. Pat. Nos. 4,583,825 and 5,410,422. Since the rod-shaped liquid-crystal molecules are aligned symmetrically between the upper part and the lower part of the liquid-crystal cell therein, the bend-alignment mode liquid-crystal cell has a self-optically compensating function. The bend-alignment mode liquid-crystal display device has the advantage of rapid response speed.

In the VA-mode liquid crystal cell, rod-shaped liquid crystal molecules are aligned substantially vertically under no voltage application.

The VA-mode liquid crystal cell includes, in addition to (1) the VA-mode liquid crystal cell of a narrow sense, where rod-shaped liquid crystal molecules are aligned substantially vertically under no voltage application and are aligned horizontally under voltage application (described in JP-A 2-176625), (2) a multidomained VA-mode (MVA-mode) liquid crystal cell with enlarged viewing angles (in SID 97, Digest of Tech. Papers (preprints) 28 (1997), 845), (3) a liquid crystal cell of an n-ASM mode in which the rod-shaped liquid crystal molecules are aligned substantially vertically under no voltage application and are aligned in twisted multi-domains under voltage application (in Sharp Technical Report, No. 80, p. 11), and (4) a liquid crystal cell of a SURVIVAL mode (in Monthly Journal of Display, May, p. 14 (1999)).

The VA-mode liquid crystal display device has a liquid crystal cell and two polarizers disposed on both sides thereof. The liquid crystal cell carries a liquid crystal between two electrode substrates. In one embodiment of a transmission-type liquid crystal display device of the invention, one film of the invention is disposed between the liquid crystal cell and one polarizer, or two films of the invention are between the liquid crystal cell and both polarizers.

In another embodiment of a transmission-type liquid crystal display device of the invention, an optically-compensatory sheet comprising the film of the invention is used as the transparent protective film of the polarizer to be disposed between the liquid crystal cell and the polarizing element. The optically-compensatory sheet may be used as only the protective film for one polarizer (between the liquid crystal cell and the polarizing element), or the optically-compensatory sheet may be used as the two protective films for both polarizers (between the liquid crystal cell and the polarizing element). In case where the optically-compensatory sheet is used only for one polarizer, preferably, the sheet serves as the protective film on the liquid crystal cell side of the backlight-side polarizer adjacent to the liquid crystal cell. When stuck to the liquid crystal cell, preferably, the film of the invention is on the VA-cell side. The protective film may be any ordinary cellulose film, and is preferably thinner than the film of the invention. For example, its thickness is preferably from 40 to 80 μm. Not limited thereto, the film includes commercial KC4UX2M (by Konica-Opto, 40 μm), KC5UX (by Konica-Opto, 60 μm), TD80 (by FUJIFILM Corporation, 80 μm), etc.

### EXAMPLES

The characteristics of the invention are described more concretely with reference to the following Examples. In the following Examples, the material used, its amount and the ratio, the details of the treatment and the treatment process may be suitably modified or changed. Accordingly, the invention should not be limitatively interpreted by the Examples mentioned below.

### Example 1

A cellulose acylate dope (a) mentioned below was formed into a film according to a solution casting process.

(Cellulose Acylate Dope a)

| | |
|---|---|
| Cellulose acylate resin: having a degree | 100 mas. pts. |
| of substitution shown in Table 4 below | |
| Compound having a negative | in an amount shown in Table 4 |
| birefringence A | (unit, mas. pt.) |
| Retardation enhancer X | in an amount shown in Table 4 |
| | (unit, mas. pt.) |
| Release promoter | 0.03 mas. pts. |
| Dichloromethane | 406 mas. pts. |
| Methanol | 61 mas. pts. |

### Retardation Enhancer X:

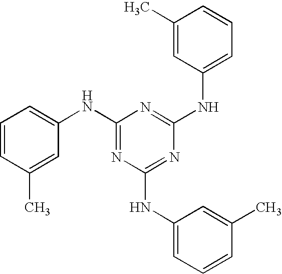

### Retardation Enhancer Y:

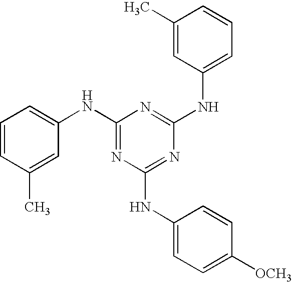

### Release Promoter:

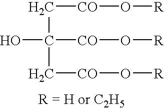

The composition of the compound having a negative birefringence A is shown in Table 3 below, along with the compositions of other compound having a negative birefringence C to P therein. In Tables 3 below, PVP represents polyvinyl pyrrolidone, PVAc represents polyvinyl acetate, series of SMA and DYLARK332 represent styrene/maleic anhydride copolymers, series of PHS represents a p-hydroxystyrene polymer, UH2180 represents a styrene/acrylic copolymer and AS300 represents an acrylic polymer.

TABLE 3

| | Compound | | Weight |
|---|---|---|---|
| | having | | average |
| | a negative | | molecular |
| | birefringence | Maker | weight |
| A | PVP | Aldrich | 10000 |
| C | PVP/PVAc = 7/3 | Aldrich | 65000 |
| D | PVP/PVAc = 3/7 | Aldrich | 25000 |
| E | SMA1000P | Sartomer | 5500 |
| F | SMA2000P | Sartomer | 7500 |
| G | SMA3000P | Sartomer | 9500 |
| H | SMA17352 | Sartomer | 7000 |
| I | DYLARK332 | NOVA Chemical | 175000 |
| J | PHS H120R | TOHO Chemical | 12000 |
| | | Industry Co., LTD. | |
| K | PHS C20A30S | TOHO Chemical | 2000 |
| | | Industry Co., LTD. | |
| L | JOHNCRYL 682 | BASF | 1700 |
| M | JOHNCRYL 586 | BASF | 4600 |
| N | UH2180 | Toagosei Company, | 7600 |
| | | Limited | |
| O | CBB3098 | Soken Chemical & | 1500 |
| | | Engineering Co., Ltd. | |
| P | AS300 | Soken Chemical & | 900 |
| | | Engineering Co., Ltd. | |

### (Solution Cast)

The cellulose acylate dope (a) was put into a mixing tank, and stirred to dissolve the constitutive ingredients, and then this was filtered through a paper filter having a mean pore size of 34 μm and through a sintered metal filter having a mean pore size of 10 μm, thereby preparing a cellulose acylate dope. The dope was cast onto a band caster. The film having a residual solvent amount of about 30% by mass was peeled away, and dried with hot air at 140° C., using a tenter. Then, this was transferred from the tenter onto a roll conveyor, then dried at 120° C. to 150° C. and wound up. The film thickness was 60 μm, then.

### (Stretching)

Using a tenter, the width of the film was expanded to a draw ratio of 32%, and then relaxed at 140° C. for 60 seconds so that its draw ratio could be 30%, thereby giving a cellulose ester film. The film thickness was 45 μm.

### Examples 2 to 49, Comparative Examples 1 to 9

Cellulose acylatee dopes were prepared in the same manner as in Example 1, for which, however, the degree of substitution of the cellulose acylate resin, the type and the amount of the compound having a negative birefringence, and the type and the amount of the retardation enhancer were changed as in Tables 4 and 5 below. The compounds having a positive birefringence, which are retardation enhancers, P-30, P-51, P-56 and P-60 were produced with materials shown in the above Table 1 and Table 2 by the method described in the two preceding paragraphs of Table 1. The type and the amount of the compounds having a positive birefringence are also shown in the column of retardation enhancer 1 in Table 4 and Table 5 below.

Next, like in Example 1, the dope was cast in a mode of solution casting and stretched, thereby producing cellulose acylate films of Examples 2 to 49 and Comparative Examples 1 to 9.

### Test Examples

### Evaluation of Film Properties

The physical properties of the cellulose acylate films of Examples 1 to 49 and Comparative Examples 1 to 9 were evaluated according to the methods mentioned below.

The properties of the films were determined according to the following methods.

### (Retardation)

Using KOBRA 21ADH (by Oji Scientific Instruments) and according to the method mentioned in the above, Re and Rth were determined at a wavelength of 590 nm. The results are shown in Table 4 and Table 5 below.

### (Wet Heat Durability)

After kept at 60° C. and relative humidity 90% for 150 hours, Re of the sample was measured. Based on the original Re of the sample just after its production, the difference of Re was computed and the change percentage of Re, ΔRe, was calculated as the difference of Re was divided by original Re.

In the same manner, after kept at 60° C. and relative humidity 90% for 150 hours, Rth of the sample was measured. Based on the original Rth of the sample just after its production, the difference of Rth was computed and the change percentage of Rth, ΔRth, was calculated as the difference of Rth was divided by original Rth.

The results are shown in Table 4 and Table 5 below.

### (Reverse Wavelength Dispersion Property)

Using KOBRA 21ADH (by Oji Scientific Instruments) and according to the method mentioned in the above, Re of the sample just after its production was determined at a wavelength of 440 nm and 630 nm. The value of Re(630)−Re (440) was calculated, wherein Re(630) means Re determined at a wavelength of 630 nm and Re(440) means Re determined at a wavelength of 440 nm. A film having positive this value of Re(630)−Re (440) is a film having a reverse wavelength dispersion property. Rth of the sample just after its production was determined at a wavelength of 440 nm and 630 nm in the same manner and the value of Rth(630)−Rth (440) was calculated, wherein Rth(630) means Rth determined at a wavelength of 630 nm and Rth(440) means Rth determined at a wavelength of 440 nm.

The results are shown in Table 5 below.

### (Haze of Film)

Using a haze meter (HGM-2DP, by Suga Test Instruments Co., Ltd.) and according to the method of JIS K-6714, the haze of a 40 mm×80 mm sample of the cellulose acylate film of the invention was analyzed.

The results are shown in Table 4 and Table 5 below.

TABLE 4

| | | | | Compounds | | | | | | | | | | | | |
|---|---|---|---|---|---|---|---|---|---|---|---|---|---|---|---|---|
| | Cellulose acylate resin | | | having a | | | | | | Film | | | | | | |
| | Degree | Degree of | Degree of | negative | | Retardation | | Retardation | | | Film | | | | | |
| | of acyl | acetyl | propionyl | birefringence | | enhancer 1 | | enhancer 2 | | Draw | thick- | | | | | |
| | sub- | sub- | sub- | | Amount | | Amount | | Amount | ratio | ness | Re | Rth | ΔRe | ΔRth | Haze |
| | stitution | stitution | stitution | Type | (mas. pt.) | Type | (mas. pt.) | Type | (mas. pt.) | (%) | (μm) | (nm) | (nm) | (%) | (%) | (%) |
| Ex. 1 | 2.45 | 2.45 | — | A | 20 | — | — | X | 4 | 30 | 45 | 42 | 112 | 5.0 | 2.1 | 0.3 |
| Ex. 2 | 2.45 | 2.45 | — | C | 20 | — | — | X | 4 | 30 | 43 | 45 | 112 | −1.1 | 0.9 | 1.8 |
| Ex. 3 | 2.45 | 2.45 | — | D | 20 | — | — | X | 4 | 30 | 44 | 45 | 109 | 4.9 | 2.4 | 2.2 |
| Ex. 4 | 2.45 | 2.45 | — | E | 5 | P56 | 15 | X | 4 | 30 | 45 | 55 | 115 | 1.1 | 0.7 | 0.3 |
| Ex. 5 | 2.45 | 2.45 | — | E | 5 | P56 | 15 | X | 2 | 30 | 82 | 62 | 202 | 0.8 | 0.6 | 0.4 |
| Ex. 6 | 2.45 | 2.45 | — | F | 5 | P56 | 15 | X | 4 | 30 | 46 | 50 | 113 | −0.6 | 0.4 | 0.3 |
| Ex. 7 | 2.45 | 2.45 | — | H | 5 | P56 | 15 | X | 4 | 30 | 47 | 53 | 115 | 1.1 | 0.7 | 0.5 |
| Comp. | 2.45 | 2.45 | — | I | 5 | P56 | 15 | X | 4 | Not evaluated owing to film whitening. | | | | | | 79 |
| Ex. 1 | | | | | | | | | | | | | | | | |
| Ex. 8 | 2.45 | 2.45 | — | J | 20 | — | — | X | 4 | 30 | 40 | 40 | 105 | −5.0 | 7.8 | 0.3 |
| Ex. 9 | 2.45 | 2.45 | — | K | 20 | — | — | X | 4 | 30 | 43 | 46 | 112 | 8.5 | 3.8 | 0.3 |
| Ex. 10 | 2.45 | 2.45 | — | K | 5 | P56 | 15 | X | 4 | 30 | 45 | 46 | 105 | 6.1 | 6.8 | 0.2 |
| Ex. 11 | 2.45 | 2.45 | — | L | 10 | P56 | 10 | X | 4 | 30 | 45 | 53 | 118 | 1.1 | 1.5 | 0.3 |
| Ex. 12 | 2.45 | 2.45 | — | O | 20 | — | — | X | 4 | 30 | 48 | 48 | 124 | 4.4 | 2.9 | 0.2 |
| Ex. 13 | 2.45 | 2.45 | — | P | 20 | — | — | X | 4 | 30 | 49 | 45 | 116 | 4.0 | 2.2 | 0.3 |
| Comp. | 2.45 | 2.45 | — | — | — | P56 | 20 | X | 4 | 30 | 46 | 50 | 115 | 24.0 | 13.9 | 0.5 |
| Ex. 2 | | | | | | | | | | | | | | | | |
| Comp. | 2.45 | 2.45 | — | K | 20 | — | — | — | — | 30 | 48 | 29 | 69 | 19.0 | 24.6 | 0.3 |
| Ex. 3 | | | | | | | | | | | | | | | | |
| Ex. 14 | 2.86 | 2.86 | — | D | 10 | P60 | 10 | Y | 8 | 30 | 45 | 42 | 112 | 9.5 | 8.2 | 0.4 |
| Ex. 15 | 2.86 | 2.86 | — | E | 3 | P60 | 12 | Y | 8 | 30 | 46 | 46 | 115 | −0.7 | −0.4 | 0.2 |
| Ex. 16 | 2.86 | 2.86 | — | F | 3 | P60 | 12 | Y | 8 | 30 | 43 | 42 | 116 | 0.5 | 0.5 | 0.3 |
| Ex. 17 | 2.86 | 2.86 | — | G | 3 | P60 | 12 | Y | 8 | 30 | 50 | 49 | 123 | −0.6 | 0.4 | 0.2 |
| Ex. 18 | 2.86 | 2.86 | — | H | 3 | P60 | 12 | Y | 8 | 30 | 46 | 42 | 115 | 1.4 | 0.7 | 0.2 |
| Comp. | 2.86 | 2.86 | — | I | 3 | P60 | 12 | Y | 8 | Not evaluated owing to film whitening. | | | | | | 68 |
| Ex. 4 | | | | | | | | | | | | | | | | |
| Ex. 19 | 2.86 | 2.86 | — | K | 12 | — | — | Y | 8 | 30 | 46 | 42 | 110 | 7.6 | 5.0 | 0.2 |
| Ex. 20 | 2.86 | 2.86 | — | L | 5 | P60 | 12 | Y | 8 | 30 | 47 | 46 | 109 | 6.1 | 3.9 | 0.3 |
| Ex. 21 | 2.86 | 2.86 | — | M | 5 | P60 | 12 | Y | 8 | 30 | 45 | 42 | 105 | 6.0 | 4.3 | 0.2 |
| Ex. 22 | 2.86 | 2.86 | — | N | 3 | P60 | 12 | Y | 8 | 30 | 46 | 48 | 110 | 0.6 | −0.5 | 0.2 |
| Comp. | 2.86 | 2.86 | — | — | — | P60 | 12 | Y | 8 | 30 | 48 | 48 | 115 | 14.6 | 20.9 | 0.2 |
| Ex. 5 | | | | | | | | | | | | | | | | |
| Ex. 23 | 2.38 | 1.54 | 0.84 | D | 5 | P51 | 12 | Y | 4 | 30 | 42 | 55 | 130 | −0.9 | −0.6 | 0.2 |
| Ex. 24 | 2.38 | 1.54 | 0.84 | G | 5 | P51 | 12 | Y | 4 | 30 | 43 | 54 | 123 | −1.1 | −0.7 | 0.3 |
| Ex. 25 | 2.38 | 1.54 | 0.84 | L | 5 | P51 | 12 | Y | 4 | 30 | 48 | 60 | 140 | 3.8 | 3.8 | 0.2 |

TABLE 5

| | | | |
|---|---|---|---|
| | Compounds | | |
| | having a | | |
| Cellulose acylate resin | negative | Retardation | Retardation |

| | Degree of | Degree of | Degree of | birefringence | | enhancer 1 | | enhancer 2 | |
|---|---|---|---|---|---|---|---|---|---|
| | acyl | acetyl | propionyl | | Amount | | Amount | | Amount |
| | substitution | substitution | substitution | Type | (mas. pt.) | Type | (mas. pt.) | Type | (mas. pt.) |
| Ex. 26 | 2.45 | 2.45 | — | E | 5 | P60 | 15 | X | 2 |
| Ex. 27 | 2.45 | 2.45 | — | F | 5 | P60 | 15 | X | 2 |
| Ex. 28 | 2.45 | 2.45 | — | G | 5 | P60 | 15 | X | 2 |
| Ex. 29 | 2.45 | 2.45 | — | H | 5 | P60 | 15 | X | 2 |
| Ex. 30 | 2.45 | 2.45 | — | E | 5 | P60 | 15 | — | — |
| Ex. 31 | 2.45 | 2.45 | — | F | 5 | P60 | 15 | — | — |
| Ex. 32 | 2.45 | 2.45 | — | G | 5 | P60 | 15 | — | — |
| Ex. 33 | 2.45 | 2.45 | — | H | 5 | P60 | 15 | — | — |
| Ex. 34 | 2.45 | 2.45 | — | K | 5 | P60 | 15 | — | — |
| Comp. | 2.45 | 2.45 | — | — | — | P60 | 15 | — | — |
| Ex. 6 | | | | | | | | | |
| Ex. 35 | 2.45 | 2.45 | — | E | 5 | P51 | 15 | — | — |
| Ex. 36 | 2.45 | 2.45 | — | F | 5 | P51 | 15 | — | — |
| Ex. 37 | 2.45 | 2.45 | — | G | 5 | P51 | 15 | — | — |
| Ex. 38 | 2.45 | 2.45 | — | H | 5 | P51 | 15 | — | — |
| Ex. 39 | 2.45 | 2.45 | — | K | 5 | P51 | 15 | — | — |
| Comp. | 2.45 | 2.45 | — | — | — | P51 | 15 | — | — |
| Ex. 7 | | | | | | | | | |
| Ex. 40 | 2.45 | 2.45 | — | E | 5 | P30 | 15 | — | — |
| Ex. 41 | 2.45 | 2.45 | — | F | 5 | P30 | 15 | — | — |
| Ex. 42 | 2.45 | 2.45 | — | G | 5 | P30 | 15 | — | — |
| Ex. 43 | 2.45 | 2.45 | — | H | 5 | P30 | 15 | — | — |
| Ex. 44 | 2.45 | 2.45 | — | K | 5 | P30 | 15 | — | — |
| Comp. | 2.45 | 2.45 | — | — | — | P30 | 15 | — | — |
| Ex. 8 | | | | | | | | | |
| Ex. 45 | 2.38 | 1.54 | 0.84 | E | 5 | P60 | 15 | — | — |
| Ex. 46 | 2.38 | 1.54 | 0.84 | F | 5 | P60 | 15 | — | — |
| Ex. 47 | 2.38 | 1.54 | 0.84 | G | 5 | P60 | 15 | — | — |
| Ex. 48 | 2.38 | 1.54 | 0.84 | H | 5 | P60 | 15 | — | — |
| Ex. 49 | 2.38 | 1.54 | 0.84 | K | 5 | P60 | 15 | — | — |
| Comp. | 2.38 | 1.54 | 0.84 | — | — | P60 | 15 | — | — |
| Ex. 9 | | | | | | | | | |

| | Film | | | | | | | | |
|---|---|---|---|---|---|---|---|---|---|
| | Draw | Film | | | | | | | |
| | ratio | thickness | | Rth | ΔRe | ΔRth | Re (630)-Re (440) | Rth (630)-Rth (440) | Haze |
| | (%) | (μm) | Re (nm) | (nm) | (%) | (%) | (nm) | (nm) | (%) |
| Ex. 26 | 30 | 38 | 53 | 122 | 0.1 | 0.5 | −1.1 | −2 | 0.2 |
| Ex. 27 | 30 | 37 | 51 | 126 | 0.2 | 0.7 | −0.6 | −1 | 0.3 |
| Ex. 28 | 30 | 41 | 54 | 125 | −0.4 | 0.6 | −0.6 | −0.2 | 0.4 |
| Ex. 29 | 30 | 40 | 53 | 124 | 0.4 | 1.1 | −0.4 | 0.1 | 0.3 |
| Ex. 30 | 30 | 42 | 42 | 114 | 2.5 | 0.9 | 3.4 | 7.9 | 0.3 |
| Ex. 31 | 30 | 43 | 45 | 109 | 2.2 | 0.8 | 3.3 | 7.7 | 0.2 |
| Ex. 32 | 30 | 45 | 45 | 107 | 2.3 | 0.8 | 3.3 | 8 | 0.4 |
| Ex. 33 | 30 | 45 | 55 | 110 | 2.1 | 0.9 | 3.2 | 7.7 | 0.3 |
| Ex. 34 | 30 | 46 | 54 | 109 | 3.0 | 1.2 | 4.3 | 10.3 | 0.4 |
| Comp. | 30 | 46 | 52 | 125 | 12.0 | 7.2 | 2.7 | 6.2 | 0.3 |
| Ex. 6 | | | | | | | | | |
| Ex. 35 | 30 | 46 | 50 | 111 | 2.3 | −0.2 | 3.2 | 8.2 | 0.3 |
| Ex. 36 | 30 | 47 | 45 | 112 | 2.8 | 0.1 | 3.2 | 8.1 | 0.5 |
| Ex. 37 | 30 | 43 | 54 | 115 | 2.4 | −0.4 | 3.3 | 7.9 | 0.5 |
| Ex. 38 | 30 | 43 | 52 | 118 | 2.0 | 0.5 | 3.3 | 7.9 | 0.3 |
| Ex. 39 | 30 | 44 | 50 | 108 | 3.2 | 0.9 | 4.5 | 10.2 | 0.3 |
| Comp. | 30 | 46 | 52 | 128 | 11.2 | 8.0 | 2.5 | 7.5 | 0.3 |
| Ex. 7 | | | | | | | | | |
| Ex. 40 | 30 | 42 | 51 | 113 | 1.3 | 0.5 | 3.2 | 8.2 | 0.3 |
| Ex. 41 | 30 | 42 | 55 | 114 | 1.2 | 0.6 | 3.3 | 8.1 | 0.4 |
| Ex. 42 | 30 | 42 | 53 | 112 | 1.5 | 0.3 | 3.3 | 8.2 | 0.3 |
| Ex. 43 | 30 | 46 | 50 | 117 | 2.0 | 0.4 | 3.2 | 7.9 | 0.3 |
| Ex. 44 | 30 | 45 | 45 | 103 | 2.9 | 1.1 | 4.4 | 11.1 | 0.4 |
| Comp. | 30 | 46 | 52 | 124 | 14.2 | 6.2 | 2.6 | 6.2 | 0.3 |
| Ex. 8 | | | | | | | | | |
| Ex. 45 | 30 | 45 | 56 | 119 | 0.2 | −0.2 | 2.9 | 8.1 | 0.3 |
| Ex. 46 | 30 | 47 | 51 | 113 | −0.5 | −0.3 | 3.2 | 7.4 | 0.4 |
| Ex. 47 | 30 | 46 | 51 | 112 | 1.0 | −0.2 | 3.3 | 7.6 | 0.3 |
| Ex. 48 | 30 | 43 | 51 | 116 | 0.8 | 0.2 | 3.1 | 7.9 | 0.4 |
| Ex. 49 | 30 | 50 | 55 | 111 | 1.4 | 0.4 | 4.2 | 9.3 | 0.2 |
| Comp. | 30 | 46 | 54 | 131 | 12.0 | 6.8 | 2.4 | 5.8 | 0.3 |
| Ex. 9 | | | | | | | | | |

From Table 4 and Table 5, it is known that the cellulose acylate films of Examples 1 to 49 of the invention have excellent wet heat durability and have a sufficiently small haze. Comparative Example 3 has revealed that the film, of which Re and Rth are not within the scope of the cellulose acylate film of the invention, has extremely increased ΔRe and ΔRth. As a common sense in the art, it may be considered that, of a film originally having low Re and Rth just after its production, the difference in Re after kept under wet heat and the difference in Rth after kept under wet heat may be small, and therefore, ΔRe (change percentage of Re after kept under wet heat) and ΔRth (change percentage of Rth after kept under wet heat) of the film may also be small. However, from comparison between Example 9 of the invention and Comparative Example 3, unexpectedly it has been known that the film originally having high Re and Rth just after its production has a smaller change of Re and Rth after kept under wet heat. Also unexpectedly, it has been known that the film originally having high Re and Rth just after its production has smaller ΔRe and ΔRth. Specifically, it has been found that for suitably controlling the wet heat durability of the optical properties of a film, the original Re and Rth of the film just after its production must be high in some degree. The knowledge is heretofore unknown in the art and could not be expected at all.

Further, it has been known that, in Comparative Examples 2 and 5 in which a compound having a negative birefringence was not added to the film, both ΔRe and ΔRth of the film are high. The cellulose acylate films of Comparative Examples 1 and 4 were whitened and could not keep a form of film.

Further, it has been known that, in Examples 26 to 49 in which, as a retardation enhancer, a compound having a positive birefringence was added to the film but a discotic compound was not added or added lesser amount to the film, value of Re(630)−Re(440) and value of Rth(630)−Rth(440) are both positive, that is, the film obtained have a reverse wavelength dispersion property.

### INDUSTRIAL APPLICABILITY

The invention has made it possible to provide a cellulose acylate film of which the retardation in the in-plane direction and the thickness-direction falls within a specific range, which is excellent in the wet heat durability of the retardation in the in-plane direction and the thickness-direction thereof, and which has a sufficiently low haze. Specifically, the cellulose acylate film of the invention is favorably used as a protective film for polarizers and an optically-compensatory film for use in high-temperature high-humidity environments.

Further, the invention has made it possible to provide a liquid-crystal display device having excellent wet heat durability.

The present disclosure relates to the subject matter contained in Japanese Patent Application No. 208742/2008 filed on Aug. 13, 2008, and in Japanese Patent Application No. 166674/2009 filed on Jul. 15, 2009, which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A cellulose acylate film comprising a cellulose acylate resin and at least one compound having a negative birefringence and satisfying the following inequalities (a) and (b):
80 nm<Re<100 nm (a)
80 nm<Rth<300 nm (b)
wherein Re indicates retardation in the plane of the cellulose acylate film and Rth indicates retardation in the thickness direction of the cellulose acylate film.

2. The cellulose acylate film according to claim 1, wherein the retardation in the plane of the cellulose acylate film changes by from −10% to 10% and the retardation in the thickness direction of the cellulose acylate film changes by from −10% to 10% after the cellulose acylate film is kept at 60° C. and relative humidity 90% for 150 hours.

3. The cellulose acylate film according to claim 1, wherein the cellulose acylate film is a stretched film.

4. The cellulose acylate film according to claim 1, comprising at least one retardation enhancer.

5. The cellulose acylate film according to claim 1, wherein the compound having a negative birefringence has a weight-average molecular weight of from 1000 to 100000.

6. The cellulose acylate film according to claim 1, wherein the cellulose acylate resin has a degree of acyl substitution of from 2.0 to 2.95.

7. The cellulose acylate film according to claim 1, wherein the cellulose acylate resin is a cellulose acetate resin.

8. The cellulose acylate film according to claim 1, having a thickness of from 30 to 100 μm.

9. A polarizer comprising the cellulose acylate film according to claim 1.
